(19) United States
(12) Patent Application Publication
(10) Pub. No.: US 2021/0392330 A1
(43) Pub. Date: Dec. 16, 2021

(54) ENTROPY ENCODING/DECODING METHOD AND APPARATUS

(71) Applicant: SAMSUNG ELECTRONICS CO., LTD., Suwon-si (KR)

(72) Inventors: Yinji PIAO, Suwon-si (KR); Kiho CHOI, Suwon-si (KR); Minsoo PARK, Suwon-si (KR); Minwoo PARK, Suwon-si (KR); Seungsoo JEONG, Suwon-si (KR); Narae CHOI, Suwon-si (KR); Woongil CHOI, Suwon-si (KR); Anish TAMSE, Suwon-si (KR)

(73) Assignee: SAMSUNG ELECTRONICS CO., LTD., Suwon-si (KR)

(21) Appl. No.: 17/285,763

(22) PCT Filed: Oct. 18, 2019
(86) PCT No.: PCT/KR2019/013776

§ 371 Date: Apr. 15, 2021

Related U.S. Application Data
(60) Provisional application No. 62/792,244, filed on Jan. 14, 2019.
(60) Provisional application No. 62/747,265, filed on Oct. 18, 2018.

(51) Int. Cl. H04N 19/13; H04N 19/91; H04N 19/30; H04N 19/174

(52) U.S. Cl. CPC H04N 19/13; H04N 19/174; H04N 19/30; H04N 19/91

(57) ABSTRACT

Provided is an entropy decoding method including: determining a plurality of scaling factors for updating an occurrence probability of a certain binary value for a current encoding symbol; performing arithmetic coding on a binary value of the current encoding symbol, based on the occurrence probability of the certain binary value; and updating the occurrence probability of the certain binary value by using at least one scaling factor of the plurality of scaling factors, according to the binary value of the current encoding symbol.

### TECHNICAL FIELD

The disclosure relates to entropy encoding and decoding, and more particularly, to a method and apparatus for updating a probability model in context-based binary arithmetic encoding/decoding.

### BACKGROUND ART

In H.264, MPEG-4, etc., video signals are hierarchically split into sequences, frames, slices, macro blocks, and blocks, wherein a block is a minimum processing unit. In view of encoding, residual data of a block is obtained through intra-frame or inter-frame prediction. Also, the residual data is compressed through transformation, quantization, scanning, run length coding, and entropy coding. As an entropy coding method, there is context-based adaptive binary arithmetic coding (CABAC). According to the CABAC, a context model is determined by using a context index ctxIdx, an occurrence probability of a least probable symbol (LPS) or a most probable symbol (MPS), which the context model has, and information valMPS about which binary value of 0 and 1 corresponds to the MPS is determined, and binary arithmetic coding is performed based on the probability of the LPS and the information valMPS.

### DESCRIPTION OF EMBODIMENTS

### Technical Problem

Various embodiments provide an improved method and apparatus for performing a probability update process in context-based binary arithmetic encoding/decoding in order to improve the compression efficiency of images.

Various embodiments provide a method and apparatus for effectively setting various parameters to be used in the probability update process, in order to reduce computational complexity and computing resources required for encoding/decoding.

### Solution to Problem

An entropy decoding method according to various embodiments of the disclosure includes: determining a plurality of scaling factors for updating an occurrence probability of a certain binary value for a current encoding symbol; performing arithmetic coding on a binary value of the current encoding symbol, based on the occurrence probability of the certain binary value; and updating the occurrence probability of the certain binary value by using at least one scaling factor of the plurality of scaling factors, according to the binary value of the current encoding symbol.

An entropy decoding apparatus according to various embodiments of the disclosure includes: at least one processor; and a memory, wherein the memory stores at least one instruction configured to be executable by the at least one processor, and the at least one instruction is set to cause, when being executed, the at least one processor to determine a plurality of scaling factors for updating an occurrence probability of a certain binary value for a current encoding symbol, based on a context model, perform arithmetic coding on a binary value of the current encoding symbol, based on the occurrence probability of the certain binary value, and update the occurrence probability of the certain binary value by using at least one scaling factor of the plurality of scaling factors, according to the binary value of the current encoding symbol.

An entropy encoding method according to various embodiments of the disclosure includes: determining a plurality of scaling factors for updating an occurrence probability of a certain binary value for a current encoding symbol, based on a context model; performing arithmetic coding on a binary value of the current encoding symbol, based on the occurrence probability of the certain binary value; and updating the occurrence probability of the certain binary value by using at least one scaling factor of the plurality of scaling factors, according to the binary value of the current encoding symbol.

An entropy encoding apparatus according to various embodiments of the disclosure includes: at least one processor; and a memory, wherein the memory stores at least one instruction configured to be executable by the at least one processor, and the at least one instruction is set to cause, when being executed, the at least one processor to determine a plurality of scaling factors for updating an occurrence probability of a certain binary value for a current encoding symbol, based on a context model, perform arithmetic coding on a binary value of the current encoding symbol, based on the occurrence probability of the certain binary value; and update the occurrence probability of the certain binary value by using at least one scaling factor of the plurality of scaling factors, according to the binary value of the current encoding symbol.

### BRIEF DESCRIPTION OF DRAWINGS

FIG. 1A is a block diagram of an image decoding apparatus according to various embodiments of the disclosure.

FIG. 1B is a block diagram of an image decoder according to various embodiments of the disclosure.

FIG. 1C is a block diagram of an image decoding apparatus according to various embodiments of the disclosure.

FIG. 2A is a block diagram of an image encoding apparatus according to various embodiments of the disclosure.

FIG. 2B is a block diagram of an image encoder according to various embodiments of the disclosure.

FIG. 2C is a block diagram of an image encoding apparatus according to various embodiments of the disclosure.

FIG. 3 illustrates a process, performed by an image decoding apparatus, of determining at least one coding unit by splitting a current coding unit, according to an embodiment of the disclosure.

FIG. 4 illustrates a process, performed by an image decoding apparatus, of determining at least one coding unit by splitting a non-square coding unit, according to an embodiment of the disclosure.

FIG. 5 illustrates a process, performed by an image decoding apparatus, of splitting a coding unit based on at least one of block shape information and split shape mode information, according to an embodiment of the disclosure.

FIG. 6 illustrates a method, performed by an image decoding apparatus, of determining a certain coding unit from among an odd number of coding units, according to an embodiment of the disclosure.

FIG. 7 illustrates an order of processing a plurality of coding units when an image decoding apparatus determines the plurality of coding units by splitting a current coding unit, according to an embodiment of the disclosure.

FIG. 8 illustrates a process, performed by an image decoding apparatus, of determining that a current coding unit is to be split into an odd number of coding units, when the coding units are not processable in a certain order, according to an embodiment of the disclosure.

FIG. 9 illustrates a process, performed by an image decoding apparatus, of determining at least one coding unit by splitting a first coding unit, according to an embodiment of the disclosure.

FIG. 10 illustrates that a shape into which a second coding unit is splittable is restricted when the second coding unit having a non-square shape, which is determined when an image decoding apparatus splits a first coding unit, satisfies a certain condition, according to an embodiment of the disclosure.

FIG. 11 illustrates a process, performed by an image decoding apparatus, of splitting a square coding unit when split shape mode information is unable to indicate that the square coding unit is split into four square coding units, according to an embodiment of the disclosure.

FIG. 12 illustrates that a processing order between a plurality of coding units may be changed depending on a process of splitting a coding unit, according to an embodiment of the disclosure.

FIG. 13 illustrates a process of determining a depth of a coding unit when a shape and size of the coding unit change, when the coding unit is recursively split such that a plurality of coding units are determined, according to an embodiment.

FIG. 14 illustrates depths that are determinable based on shapes and sizes of coding units, and part indexes (PIDs) that are for distinguishing the coding units, according to an embodiment of the disclosure.

FIG. 15 illustrates that a plurality of coding units are determined based on a plurality of certain data units included in a picture, according to an embodiment of the disclosure.

FIG. 16 illustrates a processing block that is used as criterion for determining an order of determining reference coding units included in a picture, according to an embodiment of the disclosure.

FIG. 17 is a block diagram illustrating a configuration of an entropy encoding apparatus according to an embodiment of the disclosure.

FIG. 18 illustrates a probability update process used in context-based adaptive binary arithmetic coding (CABAC).

FIGS. 19A and 19B illustrate a process of performing binary arithmetic coding based on CABAC.

FIG. 20 is a view for comparing a probability update process using one scaling factor with a probability update process using a plurality of scaling factors, according to an embodiment of the disclosure.

FIG. 21 is a flowchart illustrating a probability update method using a plurality of scaling factors, according to an embodiment of the disclosure.

FIG. 22 is a view for comparing a probability update process using one scaling factor with a probability update process using a plurality of scaling factors according to an update number of a probability, according to an embodiment of the disclosure.

FIG. 23 is a flowchart of a probability update method using a plurality of scaling factors based on an update number of a probability, according to an embodiment of the disclosure.

FIG. 24 is a flowchart of a probability update method using a plurality of scaling factors based on an update number of a probability, according to an embodiment of the disclosure.

FIG. 25 is a block diagram illustrating a configuration of an entropy decoding apparatus according to an embodiment of the disclosure.

FIG. 26 is a flowchart of a probability update method using a plurality of scaling factors, according to an embodiment of the disclosure.

### MODE OF DISCLOSURE

Advantages and features of the disclosure and a method for achieving them will be clear with reference to the accompanying drawings, in which embodiments are shown. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art, and the disclosure is only defined by the scope of the claims.

Terms used in this specification will be briefly described, and the disclosed embodiments will be described in detail.

Although general terms being widely used in the present specification were selected as terminology used in the disclosure while considering the functions of the disclosure, they may vary according to intentions of one of ordinary skill in the art, judicial precedents, the advent of new technologies, and the like. Terms arbitrarily selected by the applicant of the disclosure may also be used in a specific case. In this case, their meanings will be described in detail in the detailed description of the disclosure. Hence, the terms must be defined based on the meanings of the terms and the contents of the entire specification, not by simply stating the terms themselves.

It is to be understood that the singular forms “a,” “an,” and “the” include plural referents unless the context clearly dictates otherwise.

It will be understood that when a certain part “includes” a certain component, the part does not exclude another component but can further include another component, unless the context clearly dictates otherwise.

As used herein, the terms “portion”, “module”, or “unit” refers to a software or hardware component that performs predetermined functions. However, the term “portion”, “module” or “unit” is not limited to software or hardware. The “portion”, “module”, or “unit” may be configured in an addressable storage medium, or may be configured to run on at least one processor. Therefore, as an example, the “portion”, “module”, or “unit” includes: components such as software components, object-oriented software components, class components, and task components; processes, functions, attributes, procedures, sub-routines, segments of program codes, drivers, firmware, microcodes, circuits, data, databases, data structures, tables, arrays, and variables. Functions provided in the components and “portions”, “modules” or “units” may be combined into a smaller number of components and “portions”, “modules” and “units”, or sub-divided into additional components and “portions”, “modules” or “units”.

In an embodiment of the disclosure, the “portion”, “module”, or “unit” may be implemented as a processor and a memory. The term “processor” should be interpreted in a broad sense to include a general-purpose processor, a central processing unit (CPU), a microprocessor, a digital signal processor (DSP), a controller, a microcontroller, a state machine, etc. In some environments, the “processor” may indicate an application-specific integrated circuit (ASIC), a programmable logic device (PLD), a field programmable gate array (FPGA), etc. The term “processor” may indicate a combination of processing devices, such as, for example, a combination of a DSP and a microprocessor, a combination of a plurality of microprocessors, a combination of one or more microprocessors coupled to a DSP core, or a combination of arbitrary other similar components.

The term “memory” should be interpreted in a broad sense to include an arbitrary electronic component capable of storing electronic information. The term “memory” may indicate various types of processor-readable media, such as random access memory (RAM), read only memory (ROM), non-volatile RAM (NVRAM), programmable ROM (PROM), erasable programmable ROM (EPROM), electrically erasable PROM (EEPROM), flash memory, a magnetic or optical data storage device, registers, etc. When a processor can read information from a memory and/or write information in the memory, the memory can be considered to electronically communicate with the processor. A memory integrated into a process electronically communicates with the processor.

Hereinafter, an “image” may represent a static image such as a still image of video, or a moving image, that is, a dynamic image such as video itself.

Hereinafter, a “sample”, which is data assigned to a sampling location of an image, means data that is to be processed. For example, pixel values in an image of a spatial region and transform coefficients on a transform region may be samples. A unit including at least one of such samples may be defined as a block.

Hereinafter, embodiments will be described in detail with reference to the accompanying drawings so that the disclosure may be readily implemented by one of ordinary skill in the technical field to which the disclosure pertains. Also, in the drawings, parts irrelevant to the description will be omitted for the simplicity of explanation.

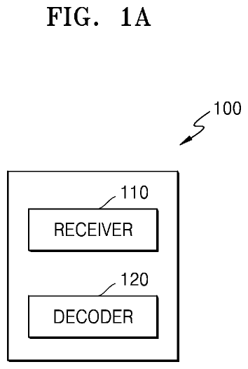

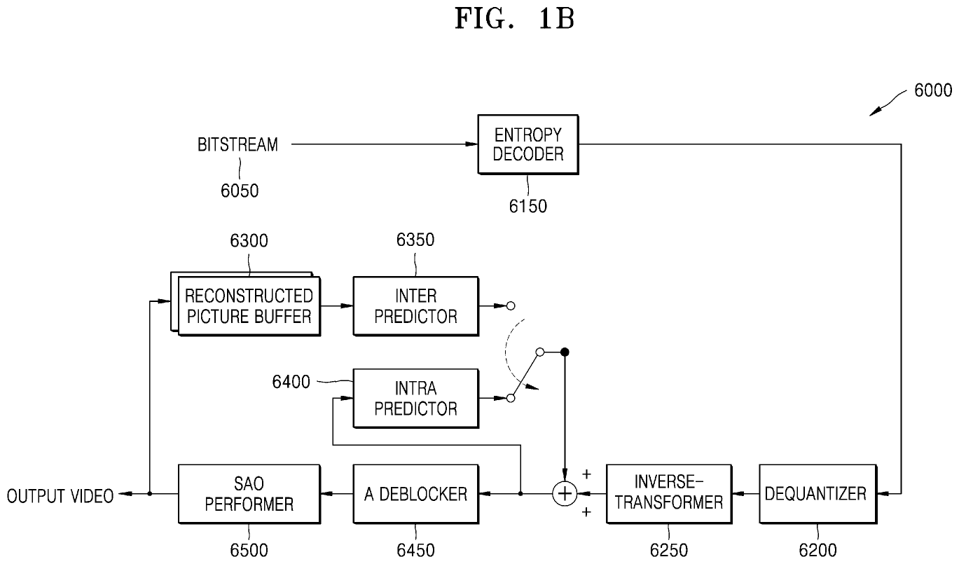

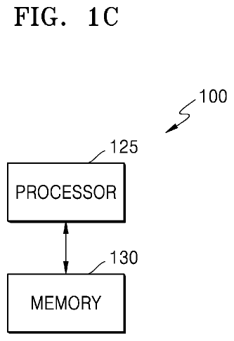

Hereinafter, preferred embodiments of the disclosure will be described in detail with reference to FIGS. 1 to 26.

FIG. 1A is a block diagram of an image decoding apparatus according to various embodiments of the disclosure.

An image decoding apparatus 100 may include a receiver 110 and a decoder 120. The receiver 110 and the decoder 120 may include at least one processor. Also, the receiver 110 and the decoder 120 may include a memory storing instructions to be performed by the at least one processor.

The receiver 110 may receive a bitstream. The bitstream includes information of an image encoded by an image encoding apparatus 2200 described later. Also, the bitstream may be transmitted from an image encoding apparatus 150. The image encoding apparatus 150 and the image decoding apparatus 100 may be connected by wire or wirelessly, and the receiver 110 may receive the bitstream by wire or wirelessly. The receiver 110 may receive the bitstream from a storage medium, such as an optical medium or a hard disk.

The decoder 120 may reconstruct an image based on information obtained from the received bitstream. The decoder 120 may obtain, from the bitstream, a syntax element for reconstructing the image. The decoder 120 may reconstruct the image based on the syntax element.

The decoder 120 may perform entropy decoding on syntax elements obtained from a bitstream, and as an entropy encoding method, context-based adaptive binary arithmetic coding (CABAC) may be used. In various embodiments, the decoder 120 may determine a plurality of scaling factors for updating an occurrence probability of a certain binary value for a current encoding symbol. The decoder 120 may perform arithmetic decoding on a binary value of the current encoding symbol, based on the occurrence probability of the certain binary value. The decoder 120 may update the occurrence probability of the certain binary value by using at least one of the plurality of scaling factors, according to the binary value of the current encoding symbol.

The operation of the image decoding apparatus 100 will be described in more detail with reference to FIG. 1B.

FIG. 1B is a block diagram of an image decoder 6000 according to various embodiments.

The image decoder 6000 according to various embodiments may perform tasks that are performed by the decoder 120 of the image decoding apparatus 100 to encode image data.

Referring to FIG. 1B, an entropy decoder 6150 may parse encoded image data being a decoding target, and encoding information required for decoding, from a bitstream 6050. The encoded image data may be a quantized transform coefficient, and a dequantizer 6200 and an inverse-transformer 6250 may reconstruct residual data from the quantized transform coefficient.

In various embodiments, the entropy decoder 6150 may determine a plurality of scaling factors for updating an occurrence probability of a certain binary value for a current encoding symbol. The entropy decoder 6150 may perform arithmetic decoding on a binary value of the current encoding symbol, based on the occurrence probability of the certain binary value. The entropy decoder 6150 may update the occurrence probability of the certain binary value by using at least one of the plurality of scaling factors, according to the binary value of the current encoding symbol.

An intra predictor 6400 may perform intra prediction on each block. An inter predictor 6350 may perform inter prediction on each block by using a reference image obtained by a reconstructed picture buffer 6300. Prediction data for each block, generated by the intra predictor 6400 or the inter predictor 6350, may be added to the residue data to reconstruct spatial-region data for the block of a current image, and a deblocker 6450 and a sample adaptive offset (SAO) performer 6500 may perform loop filtering on the reconstructed, spatial-region data to output a filtered, reconstructed image 6600. Also, reconstructed images stored in the reconstructed picture buffer 6300 may be output as reference images.

For the decoder 120 of the image decoding apparatus 100 to decode image data, phased tasks of the image decoder 6000 according to various embodiments may be performed for each block.

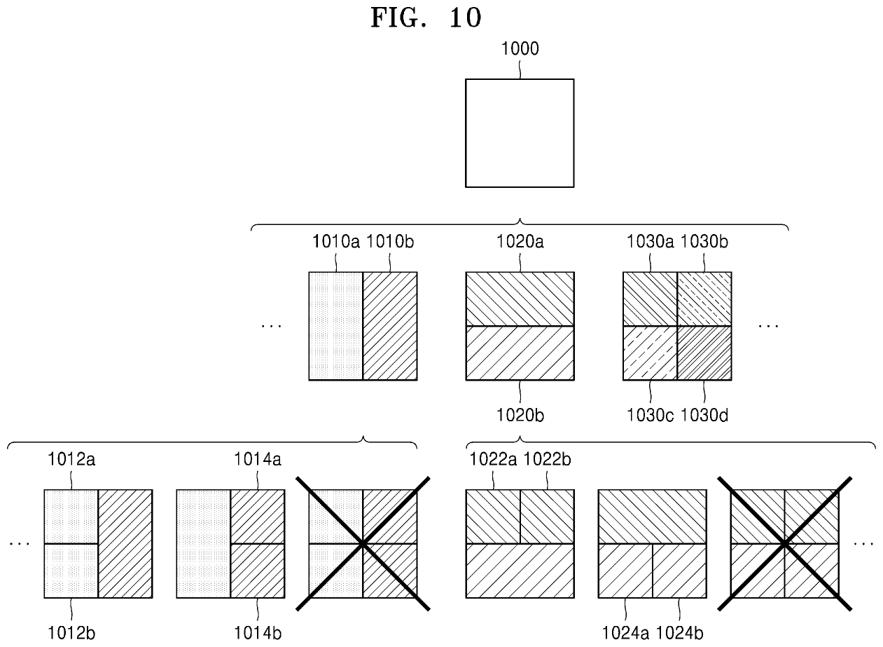

FIG. 10 is a block diagram of the image decoding apparatus 100 according to an embodiment.

The image decoding apparatus 100 according to an embodiment may include a memory 130, and at least one processor 125 connected to the memory 130. Operations of the image decoding apparatus 100 according to an embodiment may operate as individual processors, or by a control of a central processor. Also, the memory 130 of the image decoding apparatus 100 may store data received from outside, and data generated by the processor.

The memory 130 of the image decoding apparatus 100 according to various embodiments may store at least one instruction configured to be executable by the at least one processor 125. The at least one instruction may be set to cause, when being executed, the at least one processor 125 to determine a plurality of scaling factors for updating an occurrence probability of a certain binary value for a current encoding symbol, perform arithmetic decoding on a binary value of the current encoding symbol based on the occurrence probability of the certain binary value, and update the occurrence probability of the certain binary value by using at least one of the plurality of scaling factors according to the binary value of the current encoding symbol.

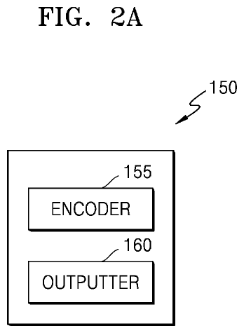

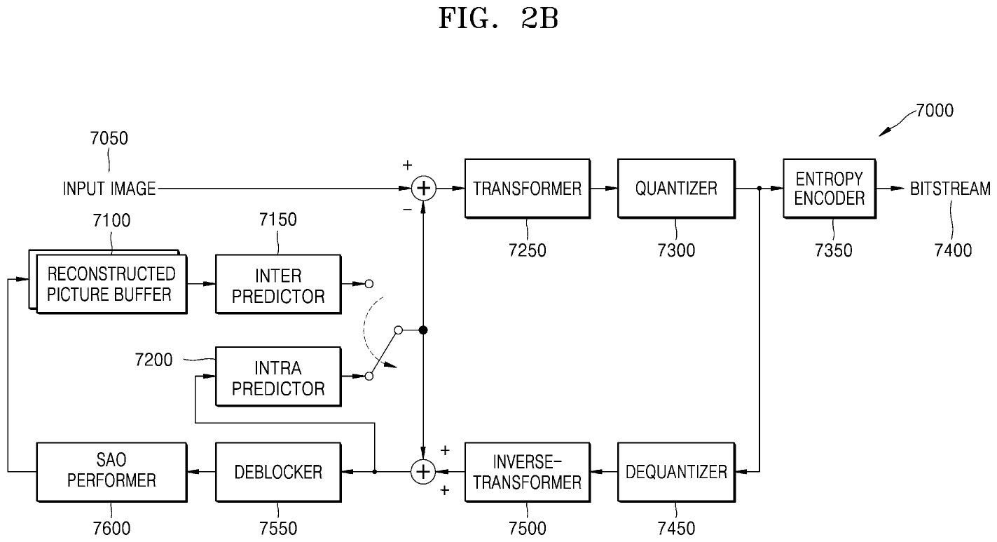

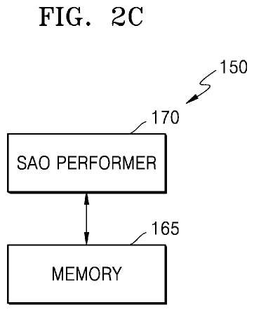

FIG. 2A is a block diagram of an image encoding apparatus according to various embodiments.

An image encoding apparatus 150 according to various embodiments may include an encoder 155 and an outputter 160.

The encoder 155 and the outputter 160 may include at least one processor. Also, the encoder 155 and the outputter 160 may include a memory storing instructions that are executed by the at least one processor. The encoder 155 and the outputter 160 may be implemented as separate pieces of hardware, or included in a single piece of hardware.

The encoder 155 may obtain a prediction block of a current block based on a prediction mode of the current block, and transform and quantize a residual being a difference between the current block and the prediction block to thereby encode the residual. The outputter 160 may generate a bitstream including information about the prediction mode of the current block, structure information for determining a data unit having a hierarchical segmentation shape, etc., and output the bitstream.

The encoder 155 may perform entropy encoding on syntax elements being encoding information generated in an encoding process, and as an entropy encoding method, CABAC may be used. In various embodiments, the encoder 155 may determine a plurality of scaling factors for updating an occurrence probability of a certain binary value for a current encoding symbol. The encoder 155 may perform arithmetic encoding on the binary value of the current encoding symbol, based on the occurrence probability of the certain binary value. The encoder 155 may update the occurrence probability of the certain binary value by using at least one of the plurality of scaling factors, according to the binary value of the current encoding symbol.

FIG. 2B is a block diagram of an image encoder according to various embodiments.

An image encoder 7000 according to various embodiments may perform tasks that are performed by the encoder 155 of the image encoding apparatus 150 to encode image data.

That is, an intra predictor 7200 may perform intra prediction on each block of a current image 7050, and an inter predictor 7150 may perform inter prediction on each block by using the current image 7050 and a reference image obtained by a reconstructed picture buffer 7100.

Prediction data for each block, output from the intra predictor 7200 or the inter predictor 7150, may be subtracted from data for an encoded block of the current image 7050 to generate residual data, and a transformer 7250 and a quantizer 7300 may perform transformation and quantization on the residual data and output a quantized transform coefficient for each block.

A dequantizer 7450 and an inverse-transformer 7500 may perform dequantization and inverse-transformation on the quantized transform coefficient to reconstruct spatial-region residual data. The reconstructed, spatial-region residual data may be added to the prediction data for the block, output from the intra predictor 7200 or the inter predictor 7150, to be reconstructed as spatial-region data for the block of the current image 7050. A deblocker 7550 and an SAO performer 7600 may perform in-loop filtering on the reconstructed, spatial-region data to generate a filtered, reconstructed image. The reconstructed image may be stored in the reconstructed picture buffer 7100. Reconstructed images stored in the reconstructed picture buffer 7100 may be used as reference images for inter prediction of other images. An entropy encoder 7350 may perform entropy encoding on the quantized transform coefficient, so that an entropy-encoded coefficient may be output as a bitstream 7400.

In various embodiments, the entropy encoder 7350 may determine a plurality of scaling factors for updating an occurrence probability of a certain binary value for a current encoding symbol, which will be described later. The entropy encoder 7350 may perform arithmetic encoding on a binary value of the current encoding symbol, based on the occurrence probability of the certain binary value. The entropy encoder 7350 may update the occurrence probability of the certain binary value by using at least one of the plurality of scaling factors, according to the binary value of the current encoding symbol.

In order to apply the image encoder 7000 according to various embodiments to the image encoding apparatus 150, phased tasks of the image encoder 7000 according to various embodiments may be performed for each block.

FIG. 2C is a block diagram of the image encoding apparatus 150 according to an embodiment.

The image encoding apparatus 150 according to an embodiment may include a memory 165 and at least one processor 170 connected to the memory 165. Operations of the image encoding apparatus 150 according to an embodiment may operate as individual processors, or by a control of a central processor. Also, the memory 165 of the image encoding apparatus 150 may store data received from outside, and data generated by the processor.

The memory 165 of the image encoding apparatus 150 according to various embodiments may include at least one instruction configured to be executable by the at least one processor 170. The at least one instruction may be set to cause, when being executed, the at least one processor 170 to determine a plurality of scaling factors for updating an occurrence probability of a certain binary value for a current encoding symbol, perform arithmetic encoding on a binary value of the current encoding symbol based on the occurrence probability of the certain binary value, and update the occurrence probability of the certain binary value by using at least one of the plurality of scaling factors according to the binary value of the current encoding symbol.

Hereinafter, splitting of a coding unit will be described in detail according to an embodiment of the disclosure.

First, one picture may be split into one or more slices or one or more tiles. One slice or one tile may be a sequence of one or more largest coding units (coding tree units (CTUs)). There is a largest coding block (coding tree block (CTB)) conceptually compared to a largest coding unit (CTU).

The largest coding unit (CTB) denotes an N×N block including N×N samples (N is an integer). Each color component may be split into one or more largest coding blocks.

When a picture has three sample arrays (sample arrays for Y, Cr, and Cb components), a largest coding unit (CTU) includes a largest coding block of a luma sample, two corresponding largest coding blocks of chroma samples, and syntax elements used to encode the luma sample and the chroma samples. When a picture is a monochrome picture, a largest coding unit includes a largest coding block of a monochrome sample and syntax elements used to encode the monochrome samples. When a picture is a picture encoded in color planes separated according to color components, a largest coding unit includes syntax elements used to encode the picture and samples of the picture.

One largest coding block (CTB) may be split into M×N coding blocks including M×N samples (M and N are integers).

When a picture has sample arrays for Y, Cr, and Cb components, a coding unit (CU) includes a coding block of a luma sample, two corresponding coding blocks of chroma samples, and syntax elements used to encode the luma sample and the chroma samples. When a picture is a monochrome picture, a coding unit includes a coding block of a monochrome sample and syntax elements used to encode the monochrome samples. When a picture is a picture encoded in color planes separated according to color components, a coding unit includes syntax elements used to encode the picture and samples of the picture.

As described above, a largest coding block and a largest coding unit are conceptually distinguished from each other, and a coding block and a coding unit are conceptually distinguished from each other. That is, a (largest) coding unit refers to a data structure including a (largest) coding block including a corresponding sample and a syntax elements corresponding to the (largest) coding block. However, because it is understood by one of ordinary skill in the art that a (largest) coding unit or a (largest) coding block refers to a block of a certain size including a certain number of samples, a largest coding block and a largest coding unit, or a coding block and a coding unit are mentioned in the following specification without being distinguished unless otherwise described.

An image may be split into largest coding units (CTUs). A size of each largest coding unit may be determined based on information obtained from a bitstream. A shape of each largest coding unit may be a square shape of the same size. However, an embodiment is not limited thereto.

For example, information about a maximum size of a luma coding block may be obtained from a bitstream. For example, the maximum size of the luma coding block indicated by the information about the maximum size of the luma coding block may be one of 16×16, 32×32, 64×64, 128×128, and 256×256.

For example, information about a luma block size difference and a maximum size of a luma coding block that may be split into two may be obtained from a bitstream. The information about the luma block size difference may refer to a size difference between a luma largest coding unit and a largest luma coding block that may be split into two. Accordingly, when the information about the maximum size of the luma coding block that may be split into two and the information about the luma block size difference obtained from the bitstream are combined with each other, a size of the luma largest coding unit may be determined. A size of a chroma largest coding unit may be determined by using the size of the luma largest coding unit. For example, when a Y:Cb:Cr ratio is 4:2:0 according to a color format, a size of a chroma block may be half a size of a luma block, and a size of a chroma largest coding unit may be half a size of a luma largest coding unit.

According to an embodiment, because information about a maximum size of a luma coding block that is binary splittable is obtained from a bitstream, the maximum size of the luma coding block that is binary splittable may be variably determined. In contrast, a maximum size of a luma coding block that is ternary splittable may be fixed. For example, the maximum size of the luma coding block that is ternary splittable in an I-picture may be 32×32, and the maximum size of the luma coding block that is ternary splittable in a P-picture or a B-picture may be 64×64.

Also, a largest coding unit may be hierarchically split into coding units based on split shape mode information obtained from a bitstream. At least one of information indicating whether quad splitting is performed, information indicating whether multi-splitting is performed, split direction information, and split type information may be obtained as the split shape mode information from the bitstream.

For example, the information indicating whether quad splitting is performed may indicate whether a current coding unit is to be quad split (QUAD_SPLIT) or is to not be quad split.

When the current coding unit is not quad split, the information indicating whether multi-splitting is performed may indicate whether the current coding unit is no longer split (NO_SPLIT) or binary/ternary split.

When the current coding unit is binary split or ternary split, the split direction information indicates that the current coding unit is split in one of a horizontal direction and a vertical direction.

When the current coding unit is split in the horizontal direction or the vertical direction, the split type information indicates that the current coding unit is binary split or ternary split.

A split mode of the current coding unit may be determined according to the split direction information and the split type information. A split mode when the current coding unit is binary split in the horizontal direction may be determined to be a binary horizontal split mode (SPLIT_BT_HOR), a split mode when the current coding unit is ternary split in the horizontal direction may be determined to be a ternary horizontal split mode (SPLIT_TT_HOR), a split mode when the current coding unit is binary split in the vertical direction may be determined to be a binary vertical split mode (SPLIT_BT_VER), and a split mode when the current coding unit is ternary split in the vertical direction may be determined to be a ternary vertical split mode SPLIT_TT_VER.

The image decoding apparatus 100 may obtain, from the bitstream, the split shape mode information from one bin string. A form of the bitstream received by the image decoding apparatus 100 may include fixed length binary code, unary code, truncated unary code, pre-determined binary code, or the like. The bin string is information in a binary number. The bin string may include at least one bit. The image decoding apparatus 100 may obtain the split shape mode information corresponding to the bin string, based on the split rule. The image decoding apparatus 100 may determine whether to quad-split a coding unit, whether to not split a coding unit, a split direction, and a split type, based on one bin string.

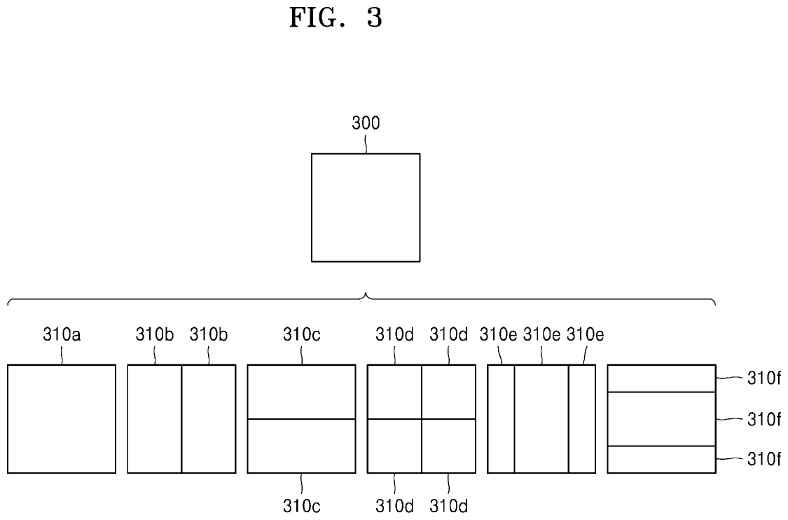

The coding unit may be smaller than or same as the largest coding unit. For example, because a largest coding unit is a coding unit having a maximum size, the largest coding unit is one of coding units. When split shape mode information about a largest coding unit indicates that splitting is not performed, a coding unit determined in the largest coding unit has the same size as that of the largest coding unit. When split shape code information about a largest coding unit indicates that splitting is performed, the largest coding unit may be split into coding units. Also, when split shape mode information about a coding unit indicates that splitting is performed, the coding unit may be split into smaller coding units. However, the splitting of the image is not limited thereto, and the largest coding unit and the coding unit may not be distinguished. The splitting of the coding unit will be described in detail with reference to FIGS. 3 through 16.

Detailed descriptions will now be provided.

Also, one or more prediction blocks for prediction may be determined from a coding unit. The prediction block may be the same as or smaller than the coding unit. Also, one or more transform blocks for transform may be determined from a coding unit. The transform block may be the same as or smaller than the coding unit.

The shapes and sizes of the transform block and prediction block may not be related to each other.

In another embodiment, prediction may be performed by using a coding unit as a prediction unit. Also, transform may be performed by using a coding unit as a transform block.

The splitting of the coding unit will be described in detail with reference to FIGS. 3 through 16. A current block and a neighboring block of the disclosure may indicate one of the largest coding unit, the coding unit, the prediction block, and the transform block. Also, the current block of the current coding unit is a block that is currently being decoded or encoded or a block that is currently being split. The neighboring block may be a block reconstructed before the current block. The neighboring block may be adjacent to the current block spatially or temporally. The neighboring block may be located at one of the lower left, left, upper left, top, upper right, right, lower right of the current block.

FIG. 3 illustrates a process, performed by the image decoding apparatus 100, of determining at least one coding unit by splitting a current coding unit, according to an embodiment.

A block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, direction, a ratio of width and height, and a size of width and height of the coding unit.

The shape of the coding unit may include a square and a non-square. When the lengths of the width and height of the coding unit are the same (i.e., when the block shape of the coding unit is 4N×4N), the image decoding apparatus 100 may determine the block shape information of the coding unit as a square. The image decoding apparatus 100 may determine the shape of the coding unit to be a non-square.

When the width and the height of the coding unit are different from each other (i.e., when the block shape of the coding unit is 4N×2N, 2N×4N, 4N×N, N×4N, 32N×N, N×32N, 16N×N, N×16N, 8N×N, or N×8N), the image decoding apparatus 100 may determine the block shape information of the coding unit as a non-square shape.

When the shape of the coding unit is non-square, the image decoding apparatus 100 may determine the ratio of the width and height among the block shape information of the coding unit to be at least one of 1:2, 2:1, 1:4, 4:1, 1:8, 8:1, 1:16, 16:1, 1:32, and 32:1. Also, the image decoding apparatus 100 may determine whether the coding unit is in a horizontal direction or a vertical direction, based on the length of the width and the length of the height of the coding unit. Also, the image decoding apparatus 100 may determine the size of the coding unit, based on at least one of the length of the width, the length of the height, or the area of the coding unit.

According to an embodiment, the image decoding apparatus 100 may determine the shape of the coding unit by using the block shape information, and may determine a splitting method of the coding unit by using the split shape mode information. That is, a coding unit splitting method indicated by the split shape mode information may be determined based on a block shape indicated by the block shape information used by the image decoding apparatus 100.

The image decoding apparatus 100 may obtain the split shape mode information from a bitstream. However, an embodiment is not limited thereto, and the image decoding apparatus 100 and the image encoding apparatus 150 may determine pre-agreed split shape mode information, based on the block shape information. The image decoding apparatus 100 may determine the pre-agreed split shape mode information with respect to a largest coding unit or a smallest coding unit. For example, the image decoding apparatus 100 may determine split shape mode information with respect to the largest coding unit to be a quad split. Also, the image decoding apparatus 100 may determine split shape mode information regarding the smallest coding unit to be “not to perform splitting”. In particular, the image decoding apparatus 100 may determine the size of the largest coding unit to be 256×256. The image decoding apparatus 100 may determine the pre-agreed split shape mode information to be a quad split. The quad split is a split shape mode in which the width and the height of the coding unit are both bisected. The image decoding apparatus 100 may obtain a coding unit of a 128×128 size from the largest coding unit of a 256×256 size, based on the split shape mode information. Also, the image decoding apparatus 100 may determine the size of the smallest coding unit to be 4×4. The image decoding apparatus 100 may obtain split shape mode information indicating “not to perform splitting” with respect to the smallest coding unit.

According to an embodiment, the image decoding apparatus 100 may use the block shape information indicating that the current coding unit has a square shape. For example, the image decoding apparatus 100 may determine whether to not split a square coding unit, whether to vertically split the square coding unit, whether to horizontally split the square coding unit, or whether to split the square coding unit into four coding units, based on the split shape mode information. Referring to FIG. 3, when the block shape information of a current coding unit 300 indicates a square shape, the decoder 120 may determine a coding unit 310a having the same size as the current coding unit 300, based on the split shape mode information indicating not to perform splitting, or may determine coding units 310b, 310c, 310d, 310e, or 310f split based on the split shape mode information indicating a certain splitting method.

Referring to FIG. 3, according to an embodiment, the image decoding apparatus 100 may determine two coding units 310b obtained by splitting the current coding unit 300 in a vertical direction, based on the split shape mode information indicating to perform splitting in a vertical direction. The image decoding apparatus 100 may determine two coding units 310c obtained by splitting the current coding unit 300 in a horizontal direction, based on the split shape mode information indicating to perform splitting in a horizontal direction. The image decoding apparatus 100 may determine four coding units 310d obtained by splitting the current coding unit 300 in vertical and horizontal directions, based on the split shape mode information indicating to perform splitting in vertical and horizontal directions. According to an embodiment, the image decoding apparatus 100 may determine three coding units 310e obtained by splitting the current coding unit 300 in a vertical direction, based on the split shape mode information indicating to perform ternary-splitting in a vertical direction. The image decoding apparatus 100 may determine three coding units 310f obtained by splitting the current coding unit 300 in a horizontal direction, based on the split shape mode information indicating to perform ternary-splitting in a horizontal direction. However, splitting methods of the square coding unit are not limited to the above-described methods, and the split shape mode information may indicate various methods. Certain splitting methods of splitting the square coding unit will be described in detail below in relation to various embodiments.

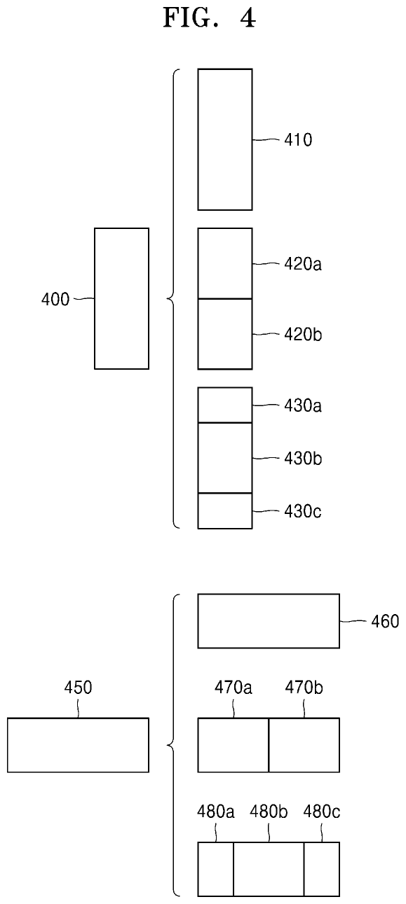

FIG. 4 illustrates a process, performed by the image decoding apparatus 100, of determining at least one coding unit by splitting a non-square coding unit, according to an embodiment.

According to an embodiment, the image decoding apparatus 100 may use block shape information indicating that a current coding unit has a non-square shape. The image decoding apparatus 100 may determine whether not to split the non-square current coding unit or whether to split the non-square current coding unit by using a certain splitting method, based on split shape mode information. Referring to FIG. 4, when the block shape information of a current coding unit 400 or 450 indicates a non-square shape, the image decoding apparatus 100 may determine a coding unit 410 or 460 having the same size as the current coding unit 400 or 450, based on the split shape mode information indicating not to perform splitting, or may determine coding units 420a and 420b, 430a to 430c, 470a and 470b, or 480a to 480c split based on the split shape mode information indicating a certain splitting method. Certain splitting methods of splitting a non-square coding unit will be described in detail below in relation to various embodiments.

According to an embodiment, the image decoding apparatus 100 may determine a splitting method of a coding unit by using the split shape mode information and, in this case, the split shape mode information may indicate the number of one or more coding units generated by splitting a coding unit. Referring to FIG. 4, when the split shape mode information indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the split shape mode information.

According to an embodiment, when the image decoding apparatus 100 splits the non-square current coding unit 400 or 450 based on the split shape mode information, the image decoding apparatus 100 may consider the location of a long side of the non-square current coding unit 400 or 450 to split a current coding unit. For example, the image decoding apparatus 100 may determine a plurality of coding units by splitting a long side of the current coding unit 400 or 450, in consideration of the shape of the current coding unit 400 or 450.

According to an embodiment, when the split shape mode information indicates to split (ternary-split) a coding unit into an odd number of blocks, the image decoding apparatus 100 may determine an odd number of coding units included in the current coding unit 400 or 450. For example, when the split shape mode information indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment, a ratio of the width and height of the current coding unit 400 or 450 may be 4:1 or 1:4. When the ratio of the width and height is 4:1, the block shape information may be a horizontal direction because the length of the width is longer than the length of the height. When the ratio of the width and height is 1:4, the block shape information may be a vertical direction because the length of the width is shorter than the length of the height. The image decoding apparatus 100 may determine to split a current coding unit into the odd number of blocks, based on the split shape mode information. Also, the image decoding apparatus 100 may determine a split direction of the current coding unit 400 or 450, based on the block shape information of the current coding unit 400 or 450. For example, when the current coding unit 400 corresponds to a vertical direction because a height of the current coding unit 400 is greater than a width of the current coding unit 400, the image decoding apparatus 100 may determine coding units 430a, 430b, and 430c by splitting the current coding unit 400 in a horizontal direction. Also, when the current coding unit 450 corresponds to a horizontal direction because a width of the current coding unit 450 is greater than a height of the current coding unit 450, the image decoding apparatus 100 may determine coding units 480a, 480b, and 480c by splitting the current coding unit 450 in a vertical direction.

According to an embodiment, the image decoding apparatus 100 may determine the odd number of coding units included in the current coding unit 400 or 450, and not all the determined coding units may have the same size. For example, a certain coding unit 430b or 480b from among the determined odd number of coding units 430a, 430b, and 430c, or 480a, 480b, and 480c may have a size different from the size of the other coding units 430a and 430c, or 480a and 480c. That is, coding units which may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the split shape mode information indicates to split a coding unit into the odd number of blocks, the image decoding apparatus 100 may determine the odd number of coding units included in the current coding unit 400 or 450, and in addition, may put a certain restriction on at least one coding unit from among the odd number of coding units generated by splitting the current coding unit 400 or 450. Referring to FIG. 4, the image decoding apparatus 100 may set a decoding process regarding the coding unit 430b or 480b located at the center among the three coding units 430a, 430b, and 430c or 480a, 480b, and 480c generated as the current coding unit 400 or 450 is split to be different from that of the other coding units 430a and 430c, or 480a or 480c. For example, the image decoding apparatus 100 may restrict the coding unit 430b or 480b at the center location to be no longer split or to be split only a certain number of times, unlike the other coding units 430a and 430c, or 480a and 480c.

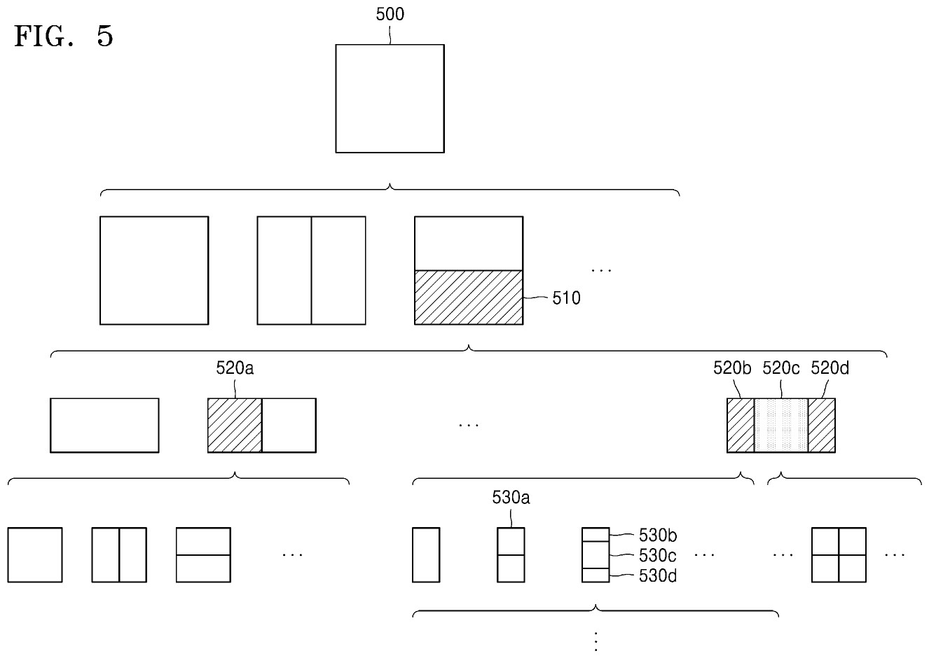

FIG. 5 illustrates a process, performed by the image decoding apparatus 100, of splitting a coding unit based on at least one of block shape information and split shape mode information, according to an embodiment.

According to an embodiment, the image decoding apparatus 100 may determine to split or to not split a square first coding unit 500 into coding units, based on at least one of the block shape information and the split shape mode information. According to an embodiment, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after splitting a coding unit. For example, a second coding unit may be determined by splitting a first coding unit, and a third coding unit may be determined by splitting the second coding unit. It will be understood that the structure of the first coding unit, the second coding unit, and the third coding unit follows the above descriptions.

According to an embodiment, the image decoding apparatus 100 may determine to split or not to split the determined second coding unit 510 into coding units, based on the split shape mode information. Referring to FIG. 5, the image decoding apparatus 100 may or may not split the non-square second coding unit 510, which is determined by splitting the first coding unit 500, into one or more third coding units 520a, or 520b, 520c, and 520d based on the split shape mode information. The image decoding apparatus 100 may obtain the split shape mode information, and may determine a plurality of various-shaped second coding units (e.g., 510) by splitting the first coding unit 500, based on the obtained split shape mode information, and the second coding unit 510 may be split by using a splitting method of the first coding unit 500 based on the split shape mode information. According to an embodiment, when the first coding unit 500 is split into the second coding units 510 based on the split shape mode information of the first coding unit 500, the second coding unit 510 may also be split into the third coding units 520a, or 520b, 520c, and 520d based on the split shape mode information of the second coding unit 510. That is, a coding unit may be recursively split based on the split shape mode information of each coding unit. Therefore, a square coding unit may be determined by splitting a non-square coding unit, and a non-square coding unit may be determined by recursively splitting the square coding unit.

Referring to FIG. 5, a certain coding unit from among the odd number of third coding units 520b, 520c, and 520d determined by splitting the non-square second coding unit 510 (e.g., a coding unit at a center location or a square coding unit) may be recursively split. According to an embodiment, the square third coding unit 520b from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in relation to various embodiments.

According to an embodiment, the image decoding apparatus 100 may split each of the third coding units 520a, or 520b, 520c, and 520d into coding units, based on the split shape mode information. Also, the image decoding apparatus 100 may determine not to split the second coding unit 510 based on the split shape mode information. According to an embodiment, the image decoding apparatus 100 may split the non-square second coding unit 510 into the odd number of third coding units 520b, 520c, and 520d. The image decoding apparatus 100 may put a certain restriction on a certain third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a certain splitting method (e.g., split into only four coding units or split by using a splitting method of the second coding unit 510), or to be split only a certain number of times (e.g., split only n times (where n>0)). However, the restrictions on the third coding unit 520c at the center location are not limited to the above-described examples, and may include various restrictions for decoding the third coding unit 520c at the center location differently from the other third coding units 520b and 520d.

According to an embodiment, the image decoding apparatus 100 may obtain the split shape mode information, which is used to split a current coding unit, from a certain location in the current coding unit.

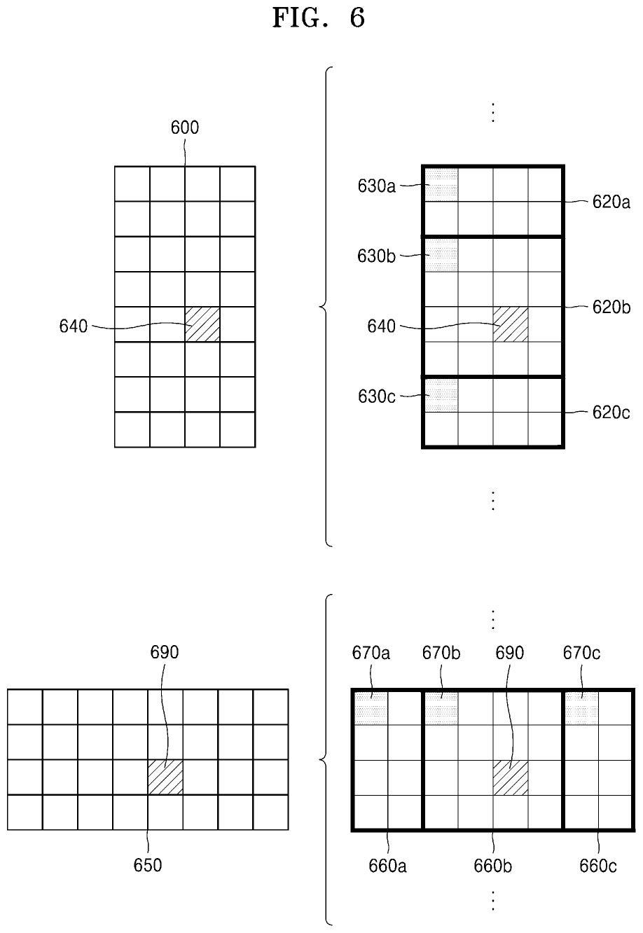

FIG. 6 illustrates a method, performed by the image decoding apparatus 100, of determining a certain coding unit from among an odd number of coding units, according to an embodiment.

Referring to FIG. 6, split shape mode information of a current coding unit 600 or 650 may be obtained from a sample of a certain location (e.g., a sample 640 or 690 of a center location) from among a plurality of samples included in the current coding unit 600 or 650. However, the certain location in the current coding unit 600, from which at least one piece of the split shape mode information may be obtained, is not limited to the center location in FIG. 6, and may include various locations included in the current coding unit 600 (e.g., top, bottom, left, right, upper left, lower left, upper right, and lower right locations). The image decoding apparatus 100 may obtain the split shape mode information from the certain location and may determine to split or to not split the current coding unit into various-shaped and various-sized coding units.

According to an embodiment, when the current coding unit is split into a certain number of coding units, the image decoding apparatus 100 may select one of the coding units. Various methods may be used to select one of a plurality of coding units, as will be described below in relation to various embodiments.

According to an embodiment, the image decoding apparatus 100 may split the current coding unit into a plurality of coding units, and may determine a coding unit at a certain location.

According to an embodiment, image decoding apparatus 100 may use information indicating locations of the odd number of coding units, to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of certain samples included in the coding units 620a, 620b, and 620c. In detail, the image decoding apparatus 100 may determine the coding unit 620b at the center location by determining the locations of the coding units 620a, 620b, and 620c based on information indicating locations of upper left samples 630a, 630b, and 630c of the coding units 620a, 620b, and 620c.

According to an embodiment, the information indicating the locations of the upper left samples 630a, 630b, and 630c, which are included in the coding units 620a, 620b, and 620c, respectively, may include information about locations or coordinates of the coding units 620a, 620b, and 620c in a picture. According to an embodiment, the information indicating the locations of the upper left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the upper left sample 630a of the upper coding unit 620a may include coordinates (xa, ya), information indicating the location of the upper left sample 630b of the middle coding unit 620b may include coordinates (xb, yb), and information indicating the location of the upper left sample 630c of the lower coding unit 620c may include coordinates (xc, yc). The image decoding apparatus 100 may determine the middle coding unit 620b by using the coordinates of the upper left samples 630a, 630b, and 630c which are included in the coding units 620a, 620b, and 620c, respectively. For example, when the coordinates of the upper left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the upper left samples 630a, 630b, and 630c may include coordinates indicating absolute locations in the picture, or may use coordinates (dxb, dyb) indicating a relative location of the upper left sample 630b of the middle coding unit 620b and coordinates (dxc, dyc) indicating a relative location of the upper left sample 630c of the lower coding unit 620c with reference to the location of the upper left sample 630a of the upper coding unit 620a. A method of determining a coding unit at a certain location by using coordinates of a sample included in the coding unit, as information indicating a location of the sample, is not limited to the above-described method, and may include various arithmetic methods capable of using the coordinates of the sample.

According to an embodiment, the image decoding apparatus 100 may split the current coding unit 600 into a plurality of coding units 620a, 620b, and 620c, and may select one of the coding units 620a, 620b, and 620c based on a certain criterion. For example, the image decoding apparatus 100 may select the coding unit 620b, which has a size different from that of the others, from among the coding units 620a, 620b, and 620c.

According to an embodiment, the image decoding apparatus 100 may determine the width or height of each of the coding units 620a, 620b, and 620c by using the coordinates (xa, ya) that is the information indicating the location of the upper left sample 630a of the upper coding unit 620a, the coordinates (xb, yb) that is the information indicating the location of the upper left sample 630b of the middle coding unit 620b, and the coordinates (xc, yc) that is the information indicating the location of the upper left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment, the image decoding apparatus 100 may determine the width of the upper coding unit 620a to be the width of the current coding unit 600. The image decoding apparatus 100 may determine the height of the upper coding unit 620a to be yb-ya. According to an embodiment, the image decoding apparatus 100 may determine the width of the middle coding unit 620b to be the width of the current coding unit 600. The image decoding apparatus 100 may determine the height of the middle coding unit 620b to be yc-yb. According to an embodiment, the image decoding apparatus 100 may determine the width or height of the lower coding unit 620c by using the width or height of the current coding unit 600 or the widths or heights of the upper and middle coding units 620a and 620b. The image decoding apparatus 100 may determine a coding unit, which has a size different from that of the others, based on the determined widths and heights of the coding units 620a to 620c. Referring to FIG. 6, the image decoding apparatus 100 may determine the middle coding unit 620b, which has a size different from the size of the upper and lower coding units 620a and 620c, as the coding unit of the certain location. However, the above-described method, performed by the image decoding apparatus 100, of determining a coding unit having a size different from the size of the other coding units merely corresponds to an example of determining a coding unit at a certain location by using the sizes of coding units, which are determined based on coordinates of samples, and thus various methods of determining a coding unit at a certain location by comparing the sizes of coding units, which are determined based on coordinates of certain samples, may be used.

The image decoding apparatus 100 may determine the width or height of each of the coding units 660a, 660b, and 660c by using the coordinates (xd, yd) that is information indicating the location of a upper left sample 670a of the left coding unit 660a, the coordinates (xe, ye) that is information indicating the location of a upper left sample 670b of the middle coding unit 660b, and the coordinates (xf, yf) that is information indicating a location of the upper left sample 670c of the right coding unit 660c. The image decoding apparatus 100 may determine the respective sizes of the coding units 660a, 660b, and 660c by using the coordinates (xd, yd), (xe, ye), and (xf, yf) indicating the locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a to be the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 650. According to an embodiment, the image decoding apparatus 100 may determine the width or height of the right coding unit 660c by using the width or height of the current coding unit 650 or the widths or heights of the left and middle coding units 660a and 660b. The image decoding apparatus 100 may determine a coding unit, which has a size different from that of the others, based on the determined widths and heights of the coding units 660a to 660c. Referring to FIG. 6, the image decoding apparatus 100 may determine the middle coding unit 660b, which has a size different from the sizes of the left and right coding units 660a and 660c, as the coding unit of the certain location. However, the above-described method, performed by the image decoding apparatus 100, of determining a coding unit having a size different from the size of the other coding units merely corresponds to an example of determining a coding unit at a certain location by using the sizes of coding units, which are determined based on coordinates of samples, and thus various methods of determining a coding unit at a certain location by comparing the sizes of coding units, which are determined based on coordinates of certain samples, may be used.

However, locations of samples considered to determine locations of coding units are not limited to the above-described upper left locations, and information about arbitrary locations of samples included in the coding units may be used.

According to an embodiment, the image decoding apparatus 100 may select a coding unit at a certain location from among an odd number of coding units determined by splitting the current coding unit, considering the shape of the current coding unit. For example, when the current coding unit has a non-square shape, a width of which is longer than a height, the image decoding apparatus 100 may determine the coding unit at the certain location in a horizontal direction. That is, the image decoding apparatus 100 may determine one of coding units at different locations in a horizontal direction and put a restriction on the coding unit. When the current coding unit has a non-square shape, a height of which is longer than a width, the image decoding apparatus 100 may determine the coding unit at the certain location in a vertical direction. That is, the image decoding apparatus 100 may determine one of coding units at different locations in a vertical direction and may put a restriction on the coding unit.

According to an embodiment, the image decoding apparatus 100 may use information indicating respective locations of an even number of coding units, to determine the coding unit at the certain location from among the even number of coding units. The image decoding apparatus 100 may determine an even number of coding units by splitting (binary-splitting) the current coding unit, and may determine the coding unit at the certain location by using the information about the locations of the even number of coding units. An operation related thereto may correspond to the operation of determining a coding unit at a certain location (e.g., a center location) from among an odd number of coding units, which has been described in detail above in relation to FIG. 6, and thus detailed descriptions thereof are not provided here.

According to an embodiment, when a non-square current coding unit is split into a plurality of coding units, certain information about a coding unit at a certain location may be used in a splitting operation to determine the coding unit at the certain location from among the plurality of coding units. For example, the image decoding apparatus 100 may use at least one of block shape information and split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of the coding units 620a, 620b, and 620c. Furthermore, the image decoding apparatus 100 may determine the coding unit 620b at the center location, in consideration of a location from which the split shape mode information is obtained. That is, the split shape mode information of the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to an embodiment, certain information for identifying the coding unit at the certain location may be obtained from a certain sample included in a coding unit to be determined. Referring to FIG. 6, the image decoding apparatus 100 may use the split shape mode information, which is obtained from a sample at a certain location in the current coding unit 600 (e.g., a sample at a center location of the current coding unit 600) to determine a coding unit at a certain location from among the plurality of the coding units 620a, 620b, and 620c determined by splitting the current coding unit 600 (e.g., a coding unit at a center location from among a plurality of split coding units). That is, the image decoding apparatus 100 may determine the sample at the certain location by considering a block shape of the current coding unit 600, may determine the coding unit 620b including a sample, from which certain information (e.g., the split shape mode information) can be obtained, from among the plurality of coding units 620a, 620b, and 620c determined by splitting the current coding unit 600, and may put a certain restriction on the coding unit 620b. Referring to FIG. 6, according to an embodiment, the image decoding apparatus 100 may determine the sample 640 at the center location of the current coding unit 600 as the sample from which the certain information may be obtained, and may put a certain restriction on the coding unit 620b including the sample 640, in a decoding operation. However, the location of the sample from which the certain information may be obtained is not limited to the above-described location, and may include arbitrary locations of samples included in the coding unit 620b to be determined for a restriction.

According to an embodiment, the location of the sample from which the certain information may be obtained may be determined based on the shape of the current coding unit 600. According to an embodiment, the block shape information may indicate whether the current coding unit has a square or non-square shape, and the location of the sample from which the certain information may be obtained may be determined based on the shape. For example, the image decoding apparatus 100 may determine a sample located on a boundary for splitting at least one of a width and height of the current coding unit in half, as the sample from which the certain information may be obtained, by using at least one of information about the width of the current coding unit and information about the height of the current coding unit. As another example, when block shape information related to a current coding unit indicates a non-square shape, the image decoding apparatus 100 may determine one of samples being adjacent to a boundary at which a longer side of the current coding unit is split in half, to be a sample from which certain information can be obtained.

According to an embodiment, when the current coding unit is split into a plurality of coding units, the image decoding apparatus 100 may use the split shape mode information to determine a coding unit at a certain location from among the plurality of coding units. According to an embodiment, the image decoding apparatus 100 may obtain the split shape mode information from a sample at a certain location in a coding unit, and may split the plurality of coding units, which are generated by splitting the current coding unit, by using the split shape mode information, which is obtained from the sample of the certain location in each of the plurality of coding units. That is, a coding unit may be recursively split based on the split shape mode information, which is obtained from the sample at the certain location in each coding unit. An operation of recursively splitting a coding unit has been described above in relation to FIG. 5, and thus detailed descriptions thereof will not be provided here.

According to an embodiment, the image decoding apparatus 100 may determine one or more coding units by splitting the current coding unit, and may determine an order of decoding the one or more coding units, based on a certain block (e.g., the current coding unit).

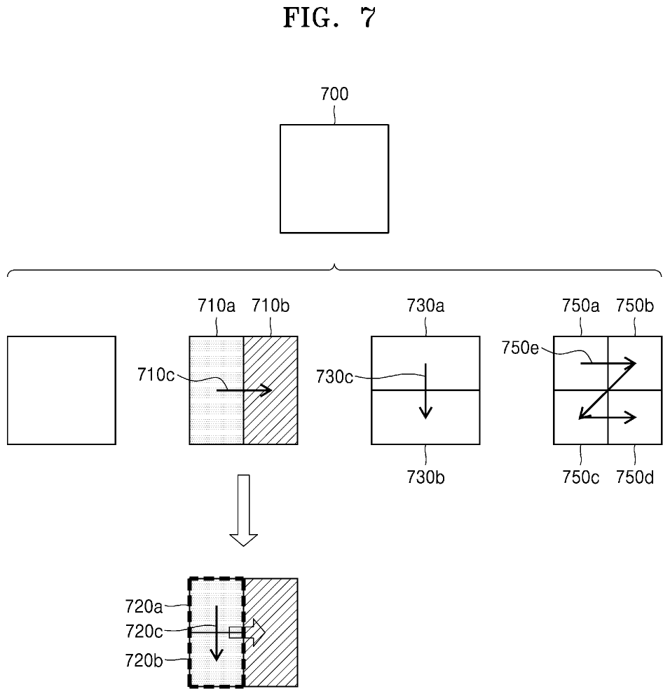

FIG. 7 illustrates an order of processing a plurality of coding units when the image decoding apparatus 100 determines the plurality of coding units by splitting a current coding unit, according to an embodiment.

According to an embodiment, the image decoding apparatus 100 may determine second coding units 710a and 710b by splitting a first coding unit 700 in a vertical direction, may determine second coding units 730a and 730b by splitting the first coding unit 700 in a horizontal direction, or may determine second coding units 750a, 750b, 750c, and 750d by splitting the first coding unit 700 in vertical and horizontal directions, based on split shape mode information.

Referring to FIG. 7, the image decoding apparatus 100 may determine to process the second coding units 710a and 710b, which are determined by splitting the first coding unit 700 in a vertical direction, in a horizontal direction order 710c. The image decoding apparatus 100 may determine to process the second coding units 730a and 730b, which are determined by splitting the first coding unit 700 in a horizontal direction, in a vertical direction order 730c. The image decoding apparatus 100 may determine to process the second coding units 750a, 750b, 750c, and 750d, which are determined by splitting the first coding unit 700 in vertical and horizontal directions, in a certain order for processing coding units in a row and then processing coding units in a next row (e.g., in a raster scan order or Z-scan order 750e).

According to an embodiment, the image decoding apparatus 100 may recursively split coding units. Referring to FIG. 7, the image decoding apparatus 100 may determine the plurality of coding units 710a and 710b, 730a and 730b, or 750a, 750b, 750c, and 750d by splitting the first coding unit 700, and may recursively split each of the determined plurality of coding units 710a and 710b, 730a and 730b, or 750a, 750b, 750c, and 750d. A splitting method of the plurality of coding units 710a and 710b, 730a and 730b, or 750a, 750b, 750c, and 750d may correspond to a splitting method of the first coding unit 700. As such, each of the plurality of coding units 710a and 710b, 730a and 730b, or 750a, 750b, 750c, and 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. Because the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and various methods may be used to independently process coding units, which are split and determined to various shapes, in a certain order.

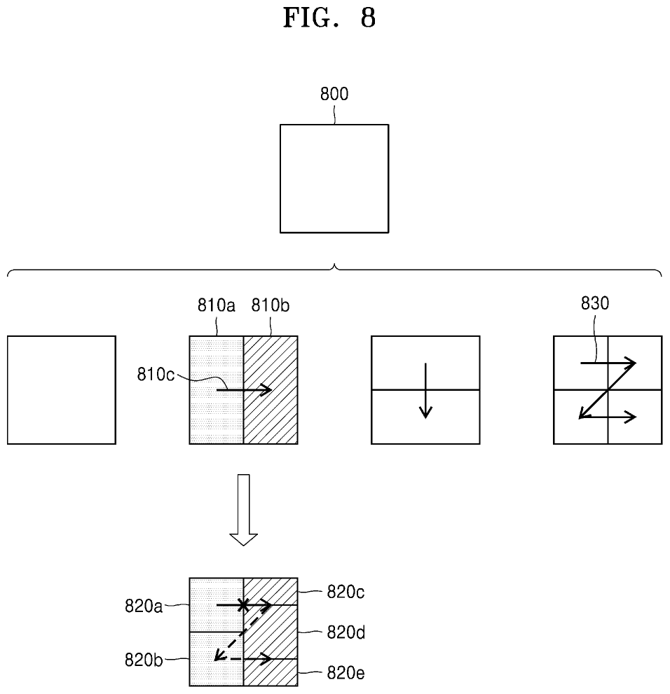

FIG. 8 illustrates a process, performed by the image decoding apparatus 100, of determining that a current coding unit is to be split into an odd number of coding units, when the coding units are not processable in a certain order, according to an embodiment.

According to an embodiment, the image decoding apparatus 100 may determine that the current coding unit is split into an odd number of coding units, based on obtained split shape mode information. Referring to FIG. 8, a square first coding unit 800 may be split into non-square second coding units 810a and 810b, and the second coding units 810a and 810b may be independently split into third coding units 820a and 820b, and 820c to 820e. According to an embodiment, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment, the image decoding apparatus 100 may determine whether any coding unit is split into an odd number of coding units, by determining whether the third coding units 820a and 820b, and 820c to 820e are processable in a certain order. Referring to FIG. 8, the image decoding apparatus 100 may determine the third coding units 820a and 820b, and 820c to 820e by recursively splitting the first coding unit 800. The image decoding apparatus 100 may determine whether any of the first coding unit 800, the second coding units 810a and 810b, and the third coding units 820a and 820b, and 820c to 820e are split into an odd number of coding units, based on at least one of the block shape information and the split shape mode information. For example, the right second coding unit 810b among the second coding units 810a and 810b may be split into an odd number of third coding units 820c, 820d, and 820e. A processing order of a plurality of coding units included in the first coding unit 800 may be a certain order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the certain order.

According to an embodiment, the image decoding apparatus 100 may determine whether the third coding units 820a and 820b, and 820c to 820e included in the first coding unit 800 satisfy the condition for processing in the certain order, and the condition relates to whether at least one of a width and height of the second coding units 810a and 810b is split in half along a boundary of the third coding units 820a and 820b, and 820c to 820e. For example, the third coding units 820a and 820b determined when the height of the left second coding unit 810a of the non-square shape is split in half may satisfy the condition. It may be determined that the third coding units 820c to 820e do not satisfy the condition because the boundaries of the third coding units 820c to 820e determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment, when a coding unit is split into an odd number of coding units, the image decoding apparatus 100 may put a certain restriction on a coding unit at a certain location from among the split coding units. The restriction or the certain location has been described above in relation to various embodiments, and thus detailed descriptions thereof will not be provided herein.

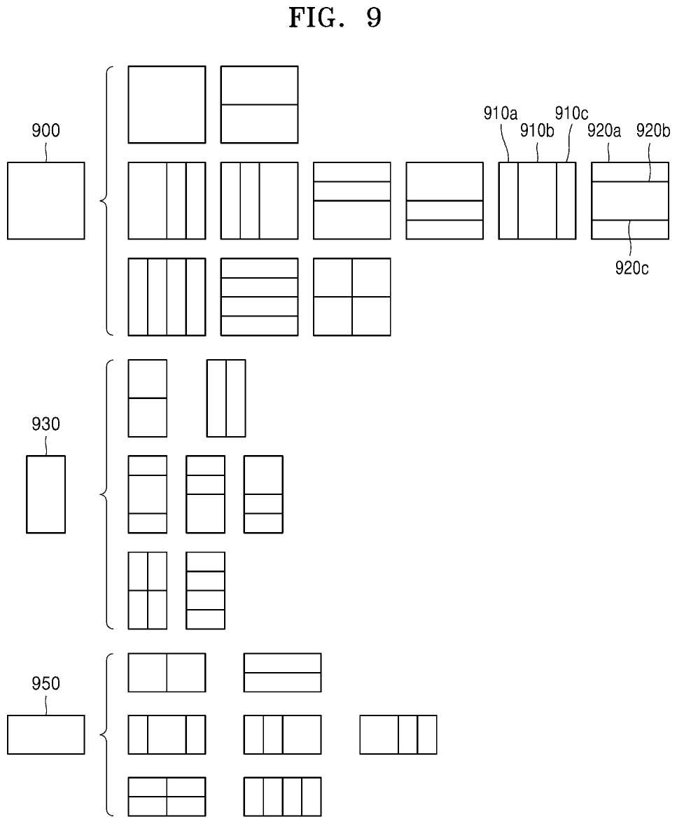

FIG. 9 illustrates a process, performed by the image decoding apparatus 100, of determining at least one coding unit by splitting a first coding unit 900, according to an embodiment.

According to an embodiment, the image decoding apparatus 100 may split the first coding unit 900, based on split shape mode information, which is obtained through a receiver (not shown). The square first coding unit 900 may be split into four square coding units, or may be split into a plurality of non-square coding units. For example, referring to FIG. 9, when the split shape mode information indicates to split the first coding unit 900 into non-square coding units, the image decoding apparatus 100 may split the first coding unit 900 into a plurality of non-square coding units. In detail, when the split shape mode information indicates to determine an odd number of coding units by splitting the first coding unit 900 in a horizontal direction or a vertical direction, the image decoding apparatus 100 may split the square first coding unit 900 into an odd number of coding units, e.g., second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a certain order, and the condition relates to whether at least one of a width and height of the first coding unit 900 is split in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not split the width of the first coding unit 900 in half, it may be determined that the first coding unit 900 does not satisfy the condition for processing in the certain order. In addition, because boundaries of the second coding units 920a, 920b, and 920c determined by splitting the square first coding unit 900 in a horizontal direction do not split the height of the first coding unit 900 in half, it may be determined that the first coding unit 900 does not satisfy the condition for processing in the certain order. When the condition is not satisfied as described above, the image decoding apparatus 100 may decide disconnection of a scan order, and may determine that the first coding unit 900 is split into an odd number of coding units, based on a result of the decision. According to an embodiment, when a coding unit is split into an odd number of coding units, the image decoding apparatus 100 may put a certain restriction on a coding unit at a certain location from among the split coding units. The restriction or the certain location has been described above in relation to various embodiments, and thus detailed descriptions thereof will not be provided herein.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

FIG. 10 illustrates that a shape into which a second coding unit is splittable is restricted when the second coding unit having a non-square shape, which is determined when the image decoding apparatus 100 splits a first coding unit 1000, satisfies a certain condition, according to an embodiment.

According to an embodiment, the image decoding apparatus 100 may determine to split the square first coding unit 1000 into non-square second coding units 1010a, and1010b or 1020a and 1020b, based on split shape mode information, which is obtained by the receiver (not shown). The second coding units 1010a and 1010b or 1020a and 1020b may be independently split. As such, the image decoding apparatus 100 may determine to split or not to split each of the second coding units 1010a and 1010b or 1020a and 1020b into a plurality of coding units, based on the split shape mode information of each of the second coding units 1010a and 1010b or 1020a and 1020b. According to an embodiment, the image decoding apparatus 100 may determine third coding units 1012a and 1012b by splitting the non-square left second coding unit 1010a, which is determined by splitting the first coding unit 1000 in a vertical direction, in a horizontal direction. However, when the left second coding unit 1010a is split in a horizontal direction, the image decoding apparatus 100 may restrict the right second coding unit 1010b to not be split in a horizontal direction in which the left second coding unit 1010a is split. When third coding units 1014a and 1014b are determined by splitting the right second coding unit 1010b in a same direction, because the left and right second coding units 1010a and 1010b are independently split in a horizontal direction, the third coding units 1012a and 1012b or 1014a and 1014b may be determined. However, this case serves equally as a case in which the image decoding apparatus 100 splits the first coding unit 1000 into four square second coding units 1030a, 1030b, 1030c, and 1030d, based on the split shape mode information, and may be inefficient in terms of image decoding.

According to an embodiment, the image decoding apparatus 100 may determine third coding units 1022a and 1022b or 1024a and 1024b by splitting the non-square second coding unit 1020a or 1020b, which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) to not be split in a vertical direction in which the upper second coding unit 1020a is split.

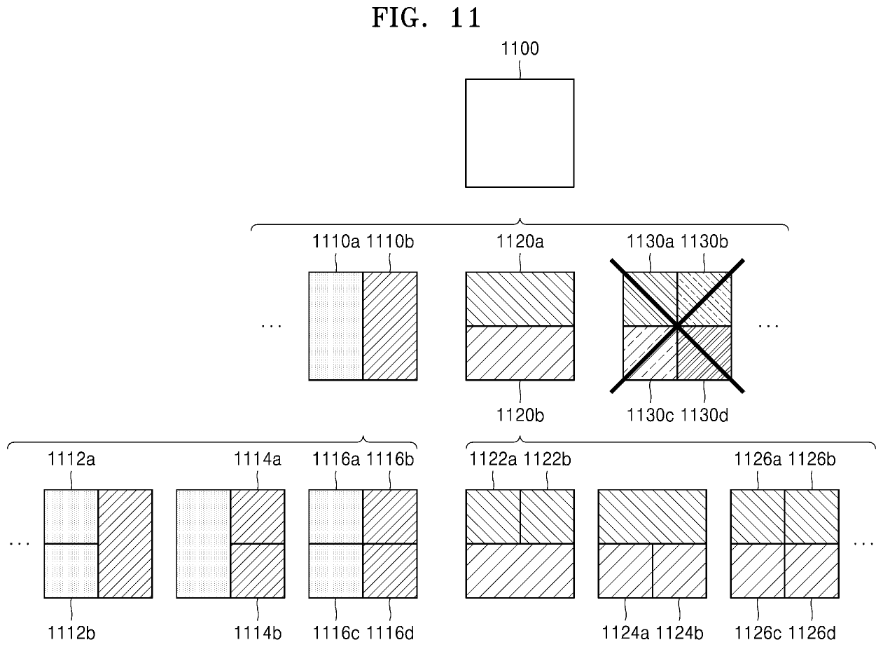

FIG. 11 illustrates a process, performed by the image decoding apparatus 100, of splitting a square coding unit when split shape mode information is unable to indicate that the square coding unit is split into four square coding units, according to an embodiment.

According to an embodiment, the image decoding apparatus 100 may determine second coding units 1110a and 1110b or 1120a and 1120b, etc. by splitting a first coding unit 1100, based on split shape mode information. The split shape mode information may include information about various methods of splitting a coding unit but, the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. The image decoding apparatus 100 may determine the non-square second coding units 1110a and 1110b or 1120a and 1120b, etc., based on the split shape mode information.

According to an embodiment, the image decoding apparatus 100 may independently split the non-square second coding units 1110a and 1110b or 1120a and 1120b, etc. Each of the second coding units 1110a and 1110b or 1120a and 1120b, etc. may be recursively split in a certain order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

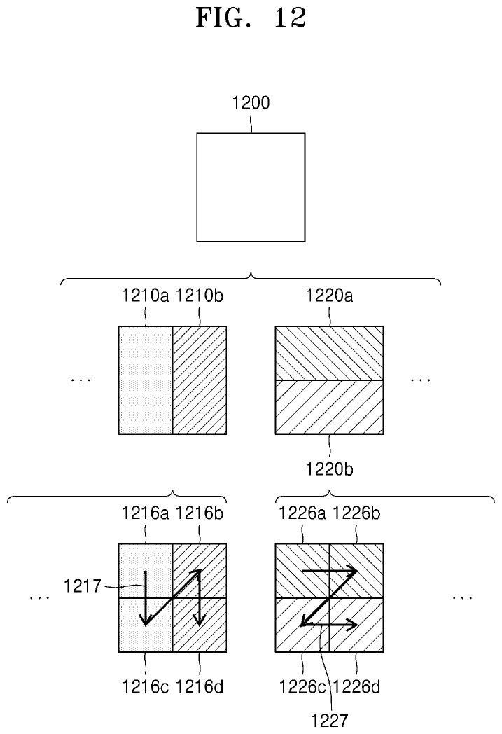

FIG. 12 illustrates that a processing order between a plurality of coding units may be changed depending on a process of splitting a coding unit, according to an embodiment.

According to an embodiment, the image decoding apparatus 100 may split a first coding unit 1200, based on split shape mode information. When a block shape indicates a square shape and the split shape mode information indicates to split the first coding unit 1200 in at least one of horizontal and vertical directions, the image decoding apparatus 100 may determine second coding units 1210a and 1210b or 1220a and 1220b, etc. by splitting the first coding unit 1200. Referring to FIG. 12, the non-square second coding units 1210a and 1210b or 1220a and 1220b determined by splitting the first coding unit 1200 in only a horizontal direction or vertical direction may be independently split based on the split shape mode information of each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a vertical direction. An operation of splitting the second coding units 1210a and 1210b or 1220a and 1220b has been described above in relation to FIG. 11, and thus detailed descriptions thereof will not be provided herein.

According to an embodiment, the image decoding apparatus 100 may process coding units in a certain order. An operation of processing coding units in a certain order has been described above in relation to FIG. 7, and thus detailed descriptions thereof will not be provided herein. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d based on a splitting method of the first coding unit 1200.

According to an embodiment, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for initially processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1920b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. As such, by recursively splitting a coding unit in different manners based on the split shape information, the image decoding apparatus 100 may process a plurality of coding units in different orders even when the coding units are eventually determined to be the same shape.

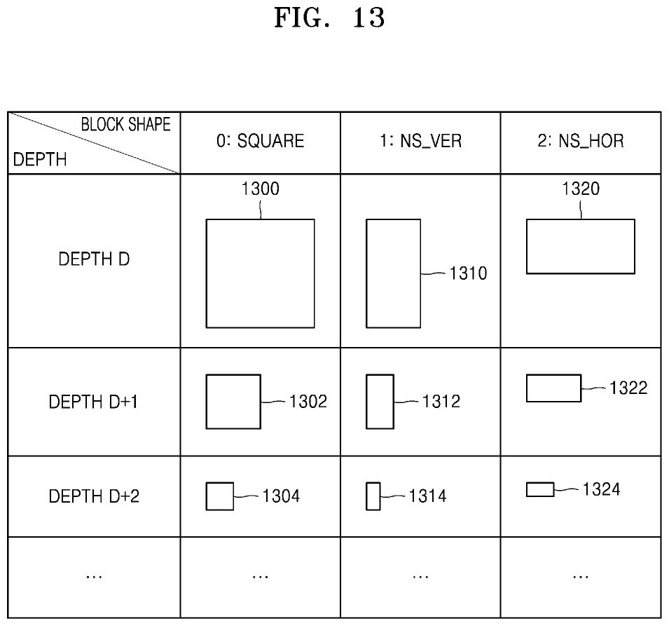

FIG. 13 illustrates a process of determining a depth of a coding unit when a shape and size of the coding unit change, when the coding unit is recursively split such that a plurality of coding units are determined, according to an embodiment.

According to an embodiment, the image decoding apparatus 100 may determine the depth of the coding unit, based on a certain criterion. For example, the certain criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. In the following description, a coding unit having an increased depth is expressed as a coding unit of a deeper depth.

Referring to FIG. 13, according to an embodiment, the image decoding apparatus 100 may determine a second coding unit 1302 and a third coding unit 1304 of deeper depths by splitting a square first coding unit 1300 based on block shape information indicating a square shape (for example, the block shape information may be expressed as ‘0: SQUARE’). Assuming that the size of the square first coding unit 1300 is 2N×2N, the second coding unit 1302 determined by splitting a width and height of the first coding unit 1300 in 1/2 may have a size of N×N. Furthermore, the third coding unit 1304 determined by splitting a width and height of the second coding unit 1302 in 1/2 may have a size of N/2×N/2. In this case, a width and height of the third coding unit 1304 are 1/4 times those of the first coding unit 1300. When a depth of the first coding unit 1300 is D, a depth of the second coding unit 1302, the width and height of which are 1/2 times those of the first coding unit 1300, may be D+1, and a depth of the third coding unit 1304, the width and height of which are 1/4 times those of the first coding unit 1300, may be D+2.

According to an embodiment, the image decoding apparatus 100 may determine a second coding unit 1312 or 1322 and a third coding unit 1314 or 1324 of deeper depths by splitting a non-square first coding unit 1310 or 1320 based on block shape information indicating a non-square shape (for example, the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 1302, 1312, or 1322 by splitting at least one of a width and height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit 1302, 1312, or 1322 by splitting at least one of a width and height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine a third coding unit 1304, 1314, or 1324 by splitting at least one of a width and height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit 1304, 1314, or 1324 by splitting at least one of a width and height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit 1304, 1314, or 1324 by splitting at least one of a width and height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit 1300, 1302, or 1304 in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be 1/4 times those of the first coding unit 1310 or 1320. When a depth of the first coding unit 1310 or 1320 is D, a depth of the second coding unit 1312 or 1322, the width and height of which are 1/2 times those of the first coding unit 1310 or 1320, may be D+1, and a depth of the third coding unit 1314 or 1324, the width and height of which are 1/4 times those of the first coding unit 1310 or 1320, may be D+2.

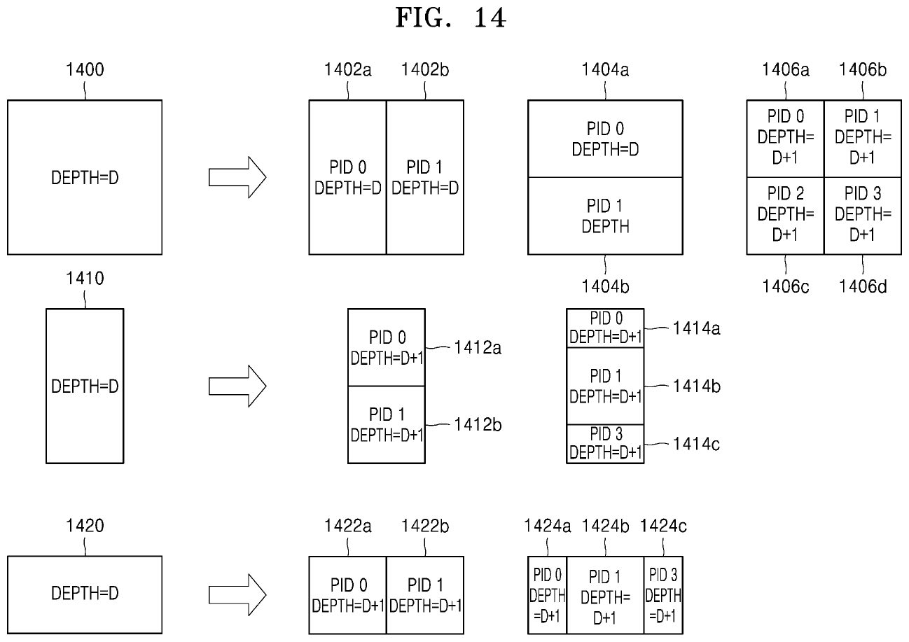

FIG. 14 illustrates depths that are determinable based on shapes and sizes of coding units, and part indexes (PIDs) that are for distinguishing the coding units, according to an embodiment.

According to an embodiment, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of vertical and horizontal directions based on split shape mode information. That is, the image decoding apparatus 100 may determine the second coding units 1402a and 1402b, 1404a and 1404b, and 1406a, 1406b, 1406c, and 1406d, based on the split shape mode information of the first coding unit 1400.

According to an embodiment, a depth of the second coding units 1402a and 1402b, 1404a and 1404b, and 1406a, 1406b, 1406c, and 1406d, which are determined based on the split shape mode information of the square first coding unit 1400, may be determined based on the length of a long side thereof. For example, because the length of a side of the square first coding unit 1400 equals the length of a long side of the non-square second coding units 1402a and 1402b, and 1404a and 1404b, the first coding unit 2100 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is 1/2 times the length of a side of the first coding unit 1400, a depth of the second coding units 1406a, 1406b, 1406c, and 1406d may be D+1 which is deeper than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to an embodiment, a depth of the second coding units 1412a and 1412b, and 1414a, 1414b, and 1414c, or 1422a and 1422b, and 1424a, 1424b, and 1424c, which are determined based on the split shape mode information of the non-square first coding unit 1410 or 1420, may be determined based on the length of a long side thereof. For example, because the length of a side of the square second coding units 1412a and 1412b is 1/2 times the length of a long side of the first coding unit 1410 having a non-square shape, a height of which is longer than a width, a depth of the square second coding units 1412a and 1412b is D+1 which is deeper than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are 1/2 times the length of a long side of the first coding unit 1410, a depth of the second coding units 1414a, 1414b, and 1414c may be D+1 which is deeper than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment, the image decoding apparatus 100 may determine PIDs for identifying split coding units, based on a size ratio between the coding units when an odd number of split coding units do not have equal sizes. Referring to FIG. 14, a coding unit 1414b of a center location among an odd number of split coding units 1414a, 1414b, and 1414c may have a width equal to that of the other coding units 1414a and 1414c and a height which is two times that of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs indicating respective coding units so as to identify respective coding units. According to an embodiment, the PID may be obtained from a sample of a certain location of each coding unit (e.g., an upper left sample).

According to an embodiment, the image decoding apparatus 100 may determine a coding unit at a certain location from among the split coding units, by using the PIDs for distinguishing the coding units. According to an embodiment, when the split shape mode information of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units to determine a coding unit at a center location from among the coding units. The image decoding apparatus 100 may determine the coding unit 1414b having a PID corresponding to a middle value among the PIDs of the coding units, as the coding unit at the center location from among the coding units determined by splitting the first coding unit 1410. According to an embodiment, the image decoding apparatus 100 may determine PIDs for distinguishing split coding units, based on a size ratio between the coding units when the split coding units do not have equal sizes. Referring to FIG. 14, the coding unit 1414b generated by splitting the first coding unit 1410 may have a width equal to that of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus may be 3. When the PID is not uniformly increased as described above, the image decoding apparatus 100 may determine that a coding unit is split into a plurality of coding units including a coding unit having a size different from that of the other coding units. According to an embodiment, when the split shape mode information indicates to split a coding unit into an odd number of coding units, the image decoding apparatus 100 may split a current coding unit in such a manner that a coding unit of a certain location among an odd number of coding units (e.g., a coding unit of a center location) has a size different from that of the other coding units. In this case, the image decoding apparatus 100 may determine the coding unit of the center location, which has a different size, by using PIDs of the coding units. However, the PIDs and the size or location of the coding unit of the certain location are not limited to the above-described examples, and various PIDs and various locations and sizes of coding units may be used.

According to an embodiment, the image decoding apparatus 100 may use a certain data unit where a coding unit starts to be recursively split.

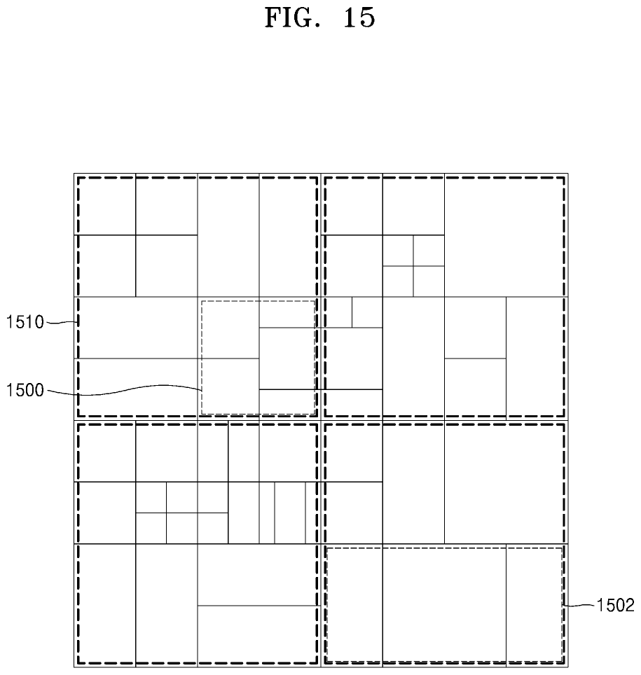

FIG. 15 illustrates that a plurality of coding units are determined based on a plurality of certain data units included in a picture, according to an embodiment.

According to an embodiment, a certain data unit may be defined as a data unit where a coding unit starts to be recursively split by using split shape mode information. That is, the certain data unit may correspond to a coding unit of an uppermost depth, which is used to determine a plurality of coding units split from a current picture. In the following descriptions, for convenience of explanation, the certain data unit is referred to as a reference data unit.

According to an embodiment, the reference data unit may have a certain size and a certain size shape. According to an embodiment, the reference data unit may include M×N samples. Herein, M and N may be equal to each other, and may be integers expressed as powers of 2. That is, the reference data unit may have a square or non-square shape, and may be split into an integer number of coding units.

According to an embodiment, the image decoding apparatus 100 may split the current picture into a plurality of reference data units. According to an embodiment, the image decoding apparatus 100 may split the plurality of reference data units, which are split from the current picture, by using the split shape mode information of each reference data unit. The operation of splitting the reference data unit may correspond to a splitting operation using a quadtree structure.

According to an embodiment, the image decoding apparatus 100 may previously determine the minimum size allowed for the reference data units included in the current picture. Accordingly, the image decoding apparatus 100 may determine various reference data units having sizes equal to or greater than the minimum size, and may determine one or more coding units by using the split shape mode information with reference to the determined reference data unit.

Referring to FIG. 15, the image decoding apparatus 100 may use a square reference coding unit 1500 or a non-square reference coding unit 1502. According to an embodiment, the shape and size of reference coding units may be determined based on various data units capable of including one or more reference coding units (e.g., sequences, pictures, slices, slice segments, tiles, tile groups, largest coding units, or the like).

According to an embodiment, the receiver (not shown) of the image decoding apparatus 100 may obtain, from a bitstream, at least one of reference coding unit shape information and reference coding unit size information with respect to each of the various data units. An operation of splitting the square reference coding unit 1500 into one or more coding units has been described above in relation to the operation of splitting the current coding unit 300 of FIG. 3, and an operation of splitting the non-square reference coding unit 1502 into one or more coding units has been described above in relation to the operation of splitting the current coding unit 400 or 450 of FIG. 4. Thus, detailed descriptions thereof will not be provided herein.

According to an embodiment, the image decoding apparatus 100 may use a PID for identifying the size and shape of reference coding units, to determine the size and shape of reference coding units according to some data units previously determined based on a certain condition. That is, the receiver (not shown) may obtain, from the bitstream, only the PID for identifying the size and shape of reference coding units with respect to each slice, slice segment, tile, tile group, or largest coding unit which is a data unit satisfying a certain condition (e.g., a data unit having a size equal to or smaller than a slice) among the various data units (e.g., sequences, pictures, slices, slice segments, tiles, tile groups, largest coding units, or the like). The image decoding apparatus 100 may determine the size and shape of reference data units with respect to each data unit, which satisfies the certain condition, by using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding apparatus 100 may determine at least one of the size and shape of reference coding units included in a data unit serving as a unit for obtaining the PID, by selecting the previously determined at least one of the size and shape of reference coding units based on the PID.

According to an embodiment, the image decoding apparatus 100 may use one or more reference coding units included in a largest coding unit. That is, a largest coding unit split from a picture may include one or more reference coding units, and coding units may be determined by recursively splitting each reference coding unit. According to an embodiment, at least one of a width and height of the largest coding unit may be integer times at least one of the width and height of the reference coding units. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information and the split shape mode information according to various embodiments.

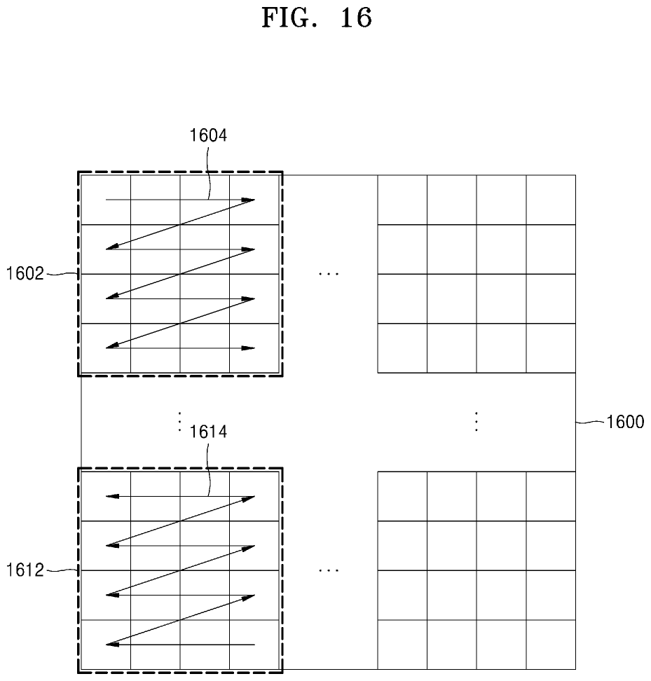

FIG. 16 illustrates a processing block that is used as criterion for determining an order of determining reference coding units included in a picture 1600, according to an embodiment.

According to an embodiment, the image decoding apparatus 100 may determine at least one processing block for splitting a picture. A processing block may be a data unit including at least one reference coding unit of splitting an image, and the at least one reference coding unit included in the processing block may be determined in a specific order. That is, an order of determining at least one reference coding unit, determined for each processing block, may be one of various order types by which reference coding units may be determined, and different processing blocks may determine reference coding units in different orders. The order of determining reference coding units, determined for each processing block, may be one of various orders, such as raster scan, Z-scan, N-scan, up-right diagonal scan, horizontal scan, vertical scan, etc., although not limited to the above-mentioned scan orders.

According to an embodiment, the image decoding apparatus 100 may obtain information about a size of a processing block to determine a size of at least one processing block included in an image. The image decoding apparatus 100 may obtain information about a size of a processing block from a bitstream to determine a size of at least one processing block included in an image. The size of the processing block may be a certain size of a data unit indicated by the information about the size of the processing block.

According to an embodiment, the receiver (not shown) of the image decoding apparatus 100 may obtain information about a size of a processing block for each specific data unit from a bitstream. For example, information about a size of a processing block may be obtained for each data unit, such as an image, a sequence, a picture, a slice, a slice segment, a tile, a tile group, etc., from a bitstream. That is, the receiver (not shown) may obtain information about a size of a processing block for each of various data units mentioned above, from a bitstream, and the image decoding apparatus 100 may determine a size of at least one processing block splitting a picture by using the obtained information about the size of the processing block, wherein the size of the processing block may be a size of a multiple of a reference coding unit.

According to an embodiment, the image decoding apparatus 100 may determine a size of processing blocks 1602 and 1612 included in the picture 1600. For example, the image decoding apparatus 100 may determine the size of the processing blocks 1602 and 1612, based on the information about the size of the processing block, obtained from the bitstream. Referring to FIG. 16, the image decoding apparatus 100 may determine a horizontal size of the processing blocks 1602 and 1612 to be four times a horizontal size of a reference coding unit, and a vertical size of the processing blocks 1602 and 1612 to be four times a vertical size of the reference coding unit, according to an embodiment. The image decoding apparatus 100 may determine an order in which at least one reference coding unit is determined in at least one processing block.

According to an embodiment, the image decoding apparatus 100 may determine the processing blocks 1602 and 1612 included in the picture 1600 based on the size of the processing block, and determine an order in which at least one reference coding unit included in the processing blocks 1602 and 1612 is determined. According to an embodiment, determining a reference coding unit may include determining a size of the reference coding unit.

According to an embodiment, the image decoding apparatus 100 may obtain, from the bitstream, information about an order of determining at least one reference coding unit included in at least one processing block, and determine an order of determining at least one reference coding unit based on the obtained information about the determination order. The information about the determination order may be defined as an order or direction in which reference coding units are determined in the processing block. That is, an order in which reference coding units are determined may be determined independently for each processing block.

According to an embodiment, the image decoding apparatus 100 may obtain information about a determination order of a reference coding unit for each specific data unit, from a bitstream. For example, the receiver (not shown) may obtain information about a determination order of a reference coding unit for each data unit, such as an image, a sequence, a picture, a slice, a slice segment, a tile, a tile group, a processing block, etc., from a bitstream. Because information about a determination order of a reference coding unit indicates an order of determining a reference coding unit in a processing block, information about a determination order may be obtained for each specific data unit including an integer number of processing blocks.

The image decoding apparatus 100 may determine at least one reference coding unit based on the determination order according to an embodiment.

According to an embodiment, the receiver (not shown) may obtain, from a bitstream, information about a determination order of reference coding units as information related to the processing blocks 1602 and 1612, and the image decoding apparatus 100 may determine an order of determining at least one reference coding unit included in the processing blocks 1602 and 1612, and determine the at least one reference coding unit included in the picture 1600 according to the determination order of the reference coding unit. Referring to FIG. 16, the image decoding apparatus 100 may determine determination orders 1604 and 1614 of the at least one reference coding unit related to the respective processing blocks 1602 and 1612. For example, when information about a determination order of a reference coding unit is obtained for each processing block, the respective processing blocks 1602 and 1612 may have different determination orders of reference encoding blocks related to the respective processing blocks 1602 and 1612. When the determination order 1604 of the reference coding unit, related to the processing block 1602, is a raster scan order, reference coding units included in the processing block 1602 may be determined in the raster scan order. In contrast, when the determination order 1614 of the reference coding unit, related to the other processing block 1612, is a reverse order of the raster scan order, reference coding units included in the processing block 1612 may be determined in the reverse order of the raster scan order.

According to an embodiment, the image decoding apparatus 100 may decode at least one determined reference coding unit. The image decoding apparatus 100 may decode an image based on a reference coding unit determined through the above-described embodiment. A method of decoding a reference coding unit may include various methods of decoding an image.

According to an embodiment, the image decoding apparatus 100 may obtain, from the bitstream, block shape information indicating the shape of a current coding unit or split shape mode information indicating a splitting method of the current coding unit, and may use the obtained information. The split shape mode information may be included in the bitstream related to various data units. For example, the image decoding apparatus 100 may use the split shape mode information included in a sequence parameter set, a picture parameter set, a video parameter set, a slice header, a slice segment header, a tile header, or a tile group header. Furthermore, the image decoding apparatus 100 may obtain, from the bitstream, a syntax element corresponding to the block shape information or the split shape mode information according to each largest coding unit, each reference coding unit, or each processing block, and may use the obtained syntax element.

Hereinafter, a method of determining a split rule, according to an embodiment of the disclosure will be described in detail.

The image decoding apparatus 100 may determine a split rule of an image. The split rule may be pre-determined between the image decoding apparatus 100 and the image encoding apparatus 150. The image decoding apparatus 100 may determine the split rule of the image, based on information obtained from a bitstream. The image decoding apparatus 100 may determine the split rule based on the information obtained from at least one of a sequence parameter set, a picture parameter set, a video parameter set, a slice header, a slice segment header, a tile header, and a tile group header. The image decoding apparatus 100 may determine the split rule differently according to frames, slices, temporal layers, largest coding units, or coding units.

The image decoding apparatus 100 may determine the split rule based on a block shape of a coding unit. The block shape may include a size, shape, a ratio of width and height, and a direction of the coding unit. The image encoding apparatus 150 and the image decoding apparatus 100 may determine in advance that a split rule is determined based on the block shape of the coding unit. However, the disclosure is not limited thereto. The image decoding apparatus 100 may determine a split rule based on information obtained from a bitstream received from the image encoding apparatus 150.

The shape of the coding unit may include a square and a non-square. When the lengths of the width and height of the coding unit are equal, the image decoding apparatus 100 may determine the shape of the coding unit to be a square. Also, when the lengths of the width and height of the coding unit are not equal, the image decoding apparatus 100 may determine the shape of the coding unit to be a non-square.

The size of the coding unit may include various sizes, such as 4×4, 8×4, 4×8, 8×8, 16×4, 16×8, and to 256×256. The size of the coding unit may be classified based on the length of a long side of the coding unit, the length of a short side, or the area. The image decoding apparatus 100 may apply the same split rule to coding units classified as the same group. For example, the image decoding apparatus 100 may classify coding units having the same lengths of the long sides as having the same size. Also, the image decoding apparatus 100 may apply the same split rule to coding units having the same lengths of long sides.

The ratio of the width and height of the coding unit may include 1:2, 2:1, 1:4, 4:1, 1:8, 8:1, 1:16, 16:1, or the like. Also, a direction of the coding unit may include a horizontal direction and a vertical direction. The horizontal direction may indicate a case in which the length of the width of the coding unit is longer than the length of the height thereof. The vertical direction may indicate a case in which the length of the width of the coding unit is shorter than the length of the height thereof.

The image decoding apparatus 100 may adaptively determine the split rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

Determining a split rule based on a size of a coding unit may be a split rule determined in advance between the image encoding apparatus 150 and the image decoding apparatus 100. Also, the image decoding apparatus 100 may determine a split rule based on information obtained from a bitstream.

The image decoding apparatus 100 may adaptively determine the split rule based on a location of the coding unit. The image decoding apparatus 100 may adaptively determine the split rule based on the location of the coding unit in the image.

Also, the image decoding apparatus 100 may determine the split rule such that coding units generated via different splitting paths do not have the same block shape. However, an embodiment is not limited thereto, and the coding units generated via different splitting paths have the same block shape. The coding units generated via the different splitting paths may have different decoding process orders. Because the decoding process orders have been described above with reference to FIG. 12, details thereof are not provided again.

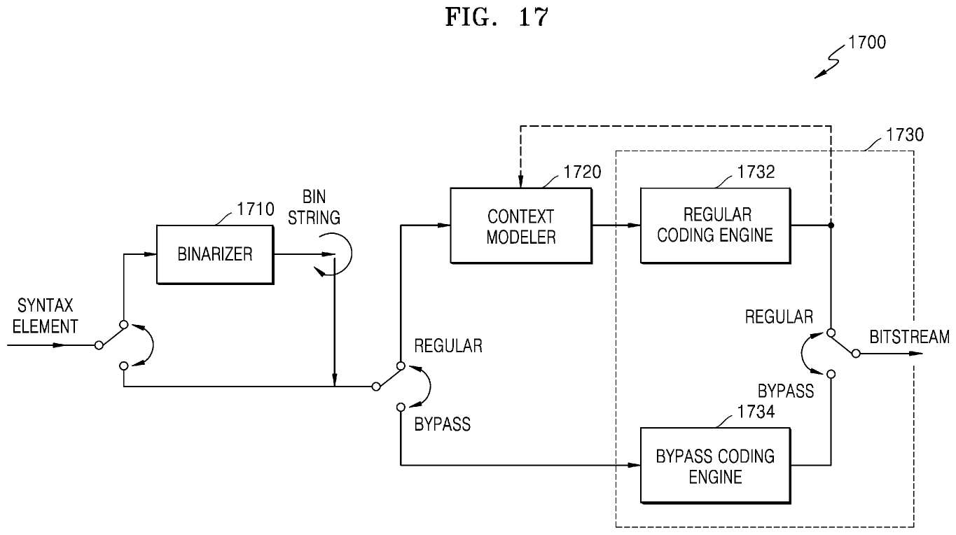

Hereinafter, a process of performing entropy encoding and decoding according to various embodiments disclosed in this specification will be described in detail with reference to FIGS. 17 to 28. The process for entropy encoding and decoding according to various embodiments may be performed by the decoder 120 of the image decoding apparatus 100 shown in FIG. 1A and the encoder 155 of the image encoding apparatus 150 shown in FIG. 2A, or by the processor 125 of the image decoding apparatus 100 shown in FIG. 10 and the processor 170 of the image encoding apparatus 150 shown in FIG. 2C. More particularly, the process for entropy encoding and decoding according to various embodiments may be performed by the entropy decoder 6150 of the decoder 6000 shown in FIG. 1B and the entropy encoder 7350 of the encoder 7000 shown in FIG. 2B.

As described above, the image encoding apparatus 150 according to an embodiment of the disclosure may perform encoding by using a coding unit resulting from hierarchically splitting a largest coding unit. The entropy encoder 7350 may perform entropy encoding on encoding information generated in an encoding process, for example, syntax elements, such as a quantized transform coefficient, a prediction mode of a prediction unit, a quantization parameter, a motion vector, etc. As an entropy encoding method, CABAC may be used.

FIG. 17 is a block diagram illustrating a configuration of an entropy encoding apparatus according to an embodiment of the disclosure.

Referring to FIG. 17, an entropy encoding apparatus 1700 according to an embodiment may include a binarizer 1710, a context modeler 1720, and a binary arithmetic coder 1730. Also, the binary arithmetic coder 1730 may include a regular coding engine 1732 and a bypass coding engine 1734.

Syntax elements input to the entropy encoding apparatus 1700 may not be binary values. In this case, the binarizer 1710 may binarize the syntax elements and output a bin string configured with binary values of 0 or 1. A bin represents each bit of a stream configured with 0 or 1, and each bin may be encoded through CABAC. A group of bins may be called a bin string. The binarizer 1710 may apply one of fixed length binarization, truncated rice binarization, k-th order exp-golomb binarization, and golomb-rice binarization according to types of the syntax elements, map values of the syntax elements to bins of 0 and 1, and output the resultant bins.

The bins output from the binarizer 1710 may be arithmetically coded by the regular coding engine 1732 and the bypass coding engine 1734. In the case in which the bins obtained by binarizing the syntax elements are distributed uniformly, that is, in the case in which the bins are data with the same frequencies of 0 and 1, the binarized bins may be output to and encoded by the bypass coding engine 1734 that does not use probability values. Whether to arithmetically code current bins by which one of the regular coding engine 1732 or the bypass coding engine 1734 may have been determined in advance according to the types of the syntax elements.

The regular coding engine 1732 may perform arithmetic coding on the bins based on a probability model determined by the context modeler 1720. The context modeler 1720 may provide a probability model for a current encoding symbol to the regular coding engine 1732. More particularly, the context modeler 1720 may determine a probability of a certain binary value based on a previously encoded bin, update a probability of a binary value used to encode the previously encoded bin, and output the updated probability to the regular coding engine 1732. According to an embodiment, the context modeler 1720 may determine a context model by using a context index ctxIdx, and determine an occurrence probability of a least probable symbol (LPS) or a most probable symbol (MPS), which the context model has, and information valMPS about which binary value of 0 and 1 corresponds to the MPS. Alternatively, according to another embodiment, the context modeler 1720 may determine P(1) representing an occurrence probability of a certain binary value (for example, “1”) without distinguishing an MPS from a LPS, based on previously encoded bins, and provide the determined occurrence probability of the certain binary value to the regular coding engine 1732.

The context modeler 1720 according to an embodiment of the disclosure may determine a plurality of scaling factors for updating an occurrence probability of a certain binary value for the current encoding symbol. The context modeler 1720 may update the occurrence probability of the certain binary value by using at least one of the plurality of scaling factors, according to a binary value of the current encoding symbol. Details about a process of updating the occurrence probability of the certain binary value will be described later.

The regular coding engine 1732 may perform binary arithmetic coding based on the occurrence probability of the certain binary value provided from the context modeler 1720 and a binary value of a current bin. That is, the regular coding engine 1732 may perform binary arithmetic coding by determining an occurrence probability P(1) of “1” and an occurrence probability of “0” based on the occurrence probability of the certain binary value provided from the context modeler 1720, splitting Range representing a probability range according to the occurrence probabilities P(0) and P(1) of “0” and “1” and the binary value of the current bin, and outputting a binary value of a representative value belonging to the split range.

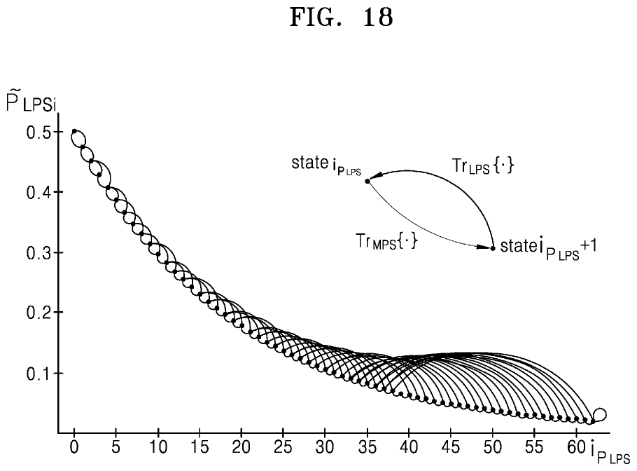

FIG. 18 illustrates a probability update process used in CABAC.

Referring to FIG. 18, context models may be defined as 64 preset probability states. Each probability state may be characterized by a state index i_{PLPS} and a value V_{MPS} of an MPS. A preset state transition table may be used to represent a probability state to which a current probability state will transit upon a probability update. A probability state may transit according to whether a value of a currently arithmetically coded bin is an MPS or an LPS. For example, when a value of a current bin is an MPS, a current probability state i_{PLPS} may transit to a forward state i_{PLPS+1} in which an LPS probability decreases, and, when the value of the current bin is an LPS, the current probability state i_{PLPS} may transit to a backward state i_{PLPS-1} in which the LPS probability increases. In FIG. 18, Tr_{MPS}{ } represents a transition direction of a probability state after MPS processing, and Tr_{LPS}{ } represents a transition direction of a probability state after LPS processing.

A probability changing upon MPS or LPS processing may have an exponentially reducing form, as shown in FIG. 18. In a probability function having such a form, a probability distribution of LPSs close to 0 may be dense, and a probability distribution of LPSs close to 1/2 may be sparse. Accordingly, when an occurrence probability of a binary value 0 is similar to an occurrence probability of binary value 1, that is, when occurrence probabilities of binary values 0 and 1 are close to 1/2, the probabilities may be distributed sparsely, resulting in an increase of prediction errors of probabilities. Also, when a probability function with an exponential form is used, probability values close to 0 may need to be expressed minutely. Accordingly, bit depths for expressing such probability values may increase. Accordingly, a size of a look-up table for storing a probability model having a probability function with an exponential form may increase. Also, when dense probability values are used to update probabilities or split a probability range, an amount of multiplication operations may increase, resulting in a hardware load. Accordingly, a probability model of which probability values are reduced in a step-wise manner, not exponentially by mapping probabilities PCPs shown in FIG. 18 to certain values through rounding-off operations, etc. may be used.

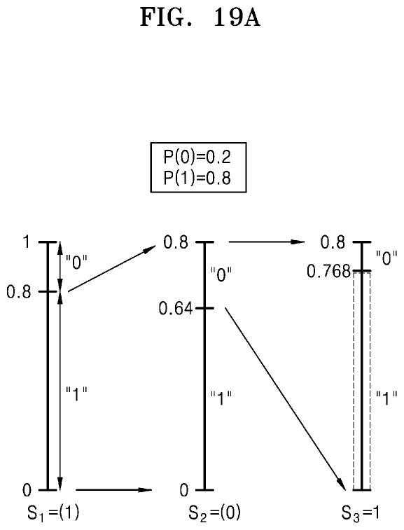

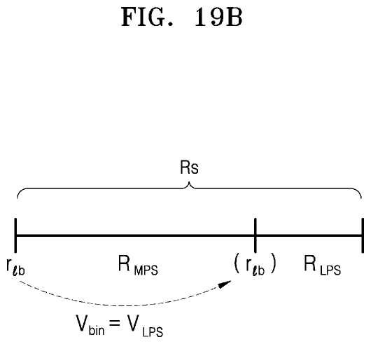

FIGS. 19A and 19B illustrate a process of performing binary arithmetic coding based on CABAC.

Referring to FIG. 19A, the context modeler 1720 may provide the regular coding engine 1732 with an occurrence probability P(1) of a certain binary value, for example, “1”. The regular coding engine 1732 may perform binary arithmetic coding by splitting a probability range considering a probability about whether an input bin is 1. In FIG. 19A, it is assumed that an occurrence probability of “1” is 0.8 (P(1)=0.8) and an occurrence probability of “0” is 0.2 (P(0)=0.2). For convenience of description, a case in which P(1) and P(0) are fixed is described, however, values of P(1) and P(0) may be updated whenever a bin is encoded, as described above. The regular coding engine 1732 may select a probability range (0, 0.8) corresponding to a value “1” in a range of (0, 1) in response to a first input bin S₁ having a value of 1, select a probability range (0.64, 0.8) corresponding to an upper portion of 0.2 of the probability range (0, 0.8) in response to a next input bin S₂ having a value of 0, and finally determine a probability range (0.64, 0.768) corresponding to 0.8 of the probability range (0.64, 0.8) in response to a final input bin S₃ having a value of 1. Then, the regular coding engine 1732 may select 0.75 as a representative value representing the probability range (0.64, 0.768), and output, as a bitstream, decimals “11” from a binary value 0.11 corresponding to 0.75. That is, input bins “101” may be mapped to “11” and output.

Referring to FIG. 19B, a binary arithmetic coding process according to CABAC may be performed by updating a currently available range Rs and a lower boundary value r_{lb} of the currently available range Rs. When binary arithmetic coding starts, Rs=510 and r_{lb}=0 may be set. When a value v_{bin} of a current bin is an MPS, the range Rs may change to R_{MPS}, and when the value v_{bin} of the current bin is an LPS, the range Rs may change to R_{LPS} and the lower boundary value rib may be updated to indicate RFPs. As understood from the above-described example of FIG. 19A, in a binary arithmetic coding process, a certain range Rs may be updated according to whether a value of a current bin is an MPS or an LPS, and a binary value representing the updated range Rs may be output.

Hereinafter, a process of updating a probability model, which is performed by the context modeler 1720, will be described in detail.

A probability update process used in CABAC may be performed according to Equation 1 below.

pᵢ(t)=αᵢy(1−αᵢ)pᵢ(t−1) [Equation 1]

In Equation 1, pᵢ(t) and pᵢ(t−1) may be occurrence probabilities of certain binary values, that is, 0 or 1, and respectively represent an updated probability and a previous probability, which are expressed as real numbers between 0 and 1. αᵢ (0≤αᵢ≤1, αᵢ is a real number) may represent a scaling factor, and y may represent a value (0 or 1) of an input current bin. i may be an integer value representing the number of scaling factors.

According to an embodiment, for simplification of operations, probability values may be represented in a range of integers, instead of a range of real numbers between 0 and 1. The probability pᵢ may be assumed to have a value of pᵢ=Pᵢ/2^{k} by using an integer Pᵢ between 0 and 2^{k} (k is an integer). Also, a plurality of scaling factors αᵢ may also be set to have a value of Equation; αᵢ=1/(2\hat{ }Shiftᵢ) (Shiftᵢ is an integer) by using exponentations of 2. In this case, a multiplication operation included in Equation 1 expressed above may be replaced with a shift operation such as Equation 2 below. In Equation 2, “>>” may be a right shift operator.

pᵢ(t)=(>>Shiftᵢ)+pᵢ(t−1)−(pᵢ(t−1)>>Shiftᵢ) [Equation 2]

In Equation 2, Pᵢ(t) and Pᵢ(t−1) may be certain binary values, that is, occurrence probabilities of 0 or 1, and respectively represent an updated probability and a previous probability, which are expressed as integers between 0 and 2^{k}. Shiftᵢ may represent a scaling factor in a log scale. Y may be 0 (Y=0) when a value of an input current bin is 0, and, when the value of the input current bin is 1, Y may be 2^{k} (Y=2^{k}). In this regard, i may be an integer value representing the number of scaling factors.

The scaling factor Shiftᵢ may correspond to a window size (Nᵢ=2\hat{ }Shiftᵢ) representing the number of bins encoded before the current bin. That is, updating a probability by using a scaling factor Shiftᵢ may represent updating a probability of a current bin by considering values of previously encoded Nᵢ bins.

A scaling factor may determine sensitiveness representing how sensitively a probability used in CABAC is updated and robustness representing how robust a probability used in CABAC is against errors. For example, when a scaling factor Shiftᵢ is small, that is, when a short window is used, a probability may be updated by using a small number of bins so that the probability changes quickly to converge quickly into a proper value. However, because of high sensitiveness to each piece of data, great fluctuations may occur. Meanwhile, when a scaling factor Shiftᵢ is great, that is, when a long window is used, fluctuations may less occur upon convergence of an updated probability into a proper value, although a probability does not change quickly, so that a stable operation is possible without causing a sensitive response to errors, noise, etc.

For balancing between sensitiveness and robustness, the context modeler 1720 according to an embodiment of the disclosure may generate, when updating a probability, a plurality of updated probabilities by using a plurality of different scaling factors, and determine a finally updated probability by using the plurality of updated probabilities.

As the number of used scaling factors increases, computational complexity may increase accordingly, although accuracy of a predicted probability may increase. Accordingly, in the following description, a case in which i is 1 or 2, that is, a case in which a probability is updated by using one or two scaling factors will be described. However, the probability update method according to the disclosure may also be applied to a case of updating a probability by using three scaling factors or more.

According to an embodiment, the context modeler 1720 may obtain, when two scaling factors are used, two updated probabilities according to Equation 3 below, and determine a finally updated probability from the two updated probabilities.

P₁(t)=(Y>>Shift₁)+P₁(t−1)−(P₁(t−1)>>Shift₁)

P₂(t)=(Y>>Shift₂)+P₂(t−1)−(P₂(t−1)>>Shift₂)

P(t)=(P₁(t)+P₂(t))/2 [Equation 3]

(P₁(t)+P₂(t))/2 may be implemented through a shift operation, like P₁(t)+P₂(t)+1)>>1.

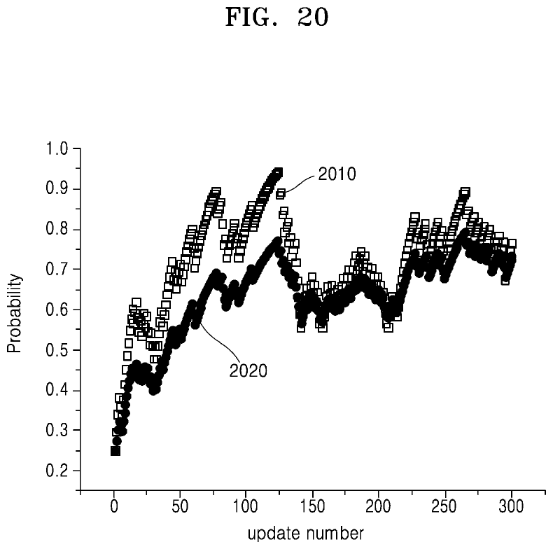

Hereinafter, a probability update method using a plurality of scaling factors will be described in detail with reference to FIGS. 20 to 24.

FIG. 20 is a view for comparing a probability update process using one scaling factor with a probability update process using a plurality of scaling factors, according to an embodiment of the disclosure.

In a CABAC encoding/decoding process, an entropy reset may be performed for each certain data unit. For example, an entropy reset may be performed for each slice unit or each coding unit. The entropy reset means discarding a current probability value and newly performing CABAC based on a certain probability value. In a probability update process that is performed after the entropy reset, a probability value set to an initial value may not be an optimal value, and converge into a certain probability value after the probability update process is performed several times.

FIG. 20 shows results of probability updates performed by two methods based on the same binary sequence and initial value. A graph 2010 represents probabilities when a scaling factor corresponding to a short window is used, and a graph 2020 represents probabilities when two scaling factors respectively corresponding to a short window and a long window are used. In FIG. 20, the x axis represents update numbers, and they axis represents probability values. Referring to FIG. 20, in the case 2010 of updating a probability using a scaling factor, the probability may change quickly to converge quickly into a proper value as an update number of the probability increases, but great fluctuations may occur as updates are repeated. Meanwhile, in the case 2020 of updating a probability using a plurality of scaling factors, according to embodiments of the disclosure, fluctuations may less occur upon convergence of an updated probability into a proper value, although the probability does not change quickly, so that a stable operation is possible without causing a sensitive response to errors, noise, etc.

Accordingly, the context modeler 1720 may determine whether to update a probability by using a plurality of scaling factors, considering probability update processes of the case of using one scaling factor and the case of using a plurality of scaling factors.

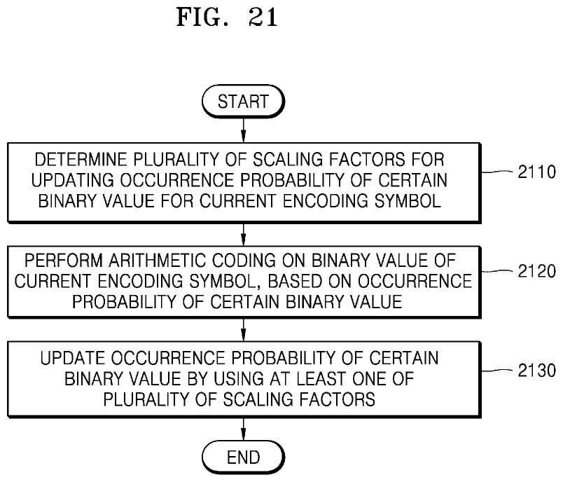

FIG. 21 is a flowchart illustrating a probability update method using a plurality of scaling factors, according to an embodiment of the disclosure.

Referring to FIG. 21, in operation 2110, the context modeler 1720 may determine a plurality of scaling factors for updating an occurrence probability of a certain binary value for a current encoding symbol.

According to an embodiment, the context modeler 1720 may determine information valMPS about which binary value of 0 and 1 corresponds to an MPS, and an occurrence probability of an LPS or an MPS. Alternatively, according to another embodiment, the context modeler 1720 may determine P(1) representing an occurrence probability of a predetermined, certain binary value, for example, “1”, without distinguishing an MPS from an LPS.

In various embodiments, the context modeler 1720 may determine values of the plurality of scaling factors within a certain range. For example, a scaling factor Shiftᵢ may have a value that is smaller than 8. According to another example, the scaling factor Shiftᵢ may have a value that is equal to or greater than 8 and smaller than 16. Different scaling factors may have different ranges of values.

In various embodiments, the context modeler 1720 may determine the plurality of scaling factors based on a context model. According to an embodiment, the plurality of scaling factors may be determined to be values customized for each context model. For example, the context modeler 1720 may obtain a plurality of scaling factor indices shiftIdx customized for each context model, and determine a value corresponding to each scaling factor index to be a scaling factor.

According to an embodiment, when a scaling factor Shiftᵢ has a limited range of values, the scaling factor Shiftᵢ may be represented by adding a minimum value to a scaling factor index shiftIdxᵢ customized for each context model. For example, a scaling factor may be calculated according to Equation 4 below.

Shift₁=a₁+shifIdx₁

Shift₂=a₂+Shift₁+shiftIdx₂ [Equation 4]

Herein, a₁ and a₂ may be certain minimum values. For example, when each of shiftIdx₁ and shiftIdx₂ is represented by 2 bits, shiftIdx₁ and shiftIdx₂ may have values of 0 to 3, and in this case, for example, when a₁ has been set in advance to 2 and a₂ has been set in advance to 3, a value of Shift₁ may be determined within a range of 2 to 5, and a value of Shift₂ may be determined within a range of 5 to 11.

To customize a scaling factor according to a context model, an additional memory space for a certain scaling factor table may be required. That is, when n bits are required to represent a value of each scaling factor Shift, a memory corresponding to n*2*[the number of context models] bits may be required to define two scaling factors for each context model. For example, when a scaling factor is represented by 4 bits and 400 context models are provided, a table of customizing two scaling factors for each context model may require ROM of 3200 bits (4*2*400=3200).

Accordingly, the context modeler 1720 according to various embodiments may determine all or some of a plurality of scaling factors based on values being irrelevant to a context model, thereby saving a memory required for determining scaling factors.

According to an embodiment, only some context models may be set to use scaling factors customized for the context models. For example, only context models for coefficient coding may have customized scaling factors. Also, according to another example, only other context models except for context models for coefficient coding may have customized scaling factors. When a context model has no customized value of a scaling factor, the context modeler 1720 may determine the plurality of scaling factors to be a certain reference value.

According to an embodiment, at least one of the plurality of scaling factors may be determined to be a certain value being irrelevant to a context model. For example, the context modeler 1720 may determine a first scaling factor Shift₁ corresponding to a short window among two scaling factors to be a fixed value M for all context models, and determine a second scaling factor Shift₂ corresponding to a long window to be a value customized according to a context model. Also, on the contrary, the context modeler 1720 may determine the second scaling factor Shift₂ to be a fixed value, and determine the first scaling factor Shift₁ to be a value customized according to a context model.

In another embodiment, the plurality of scaling factors may be determined such that a sum or difference of the plurality of scaling factors becomes a certain value being irrelevant to a context model. For example, when a difference between two scaling factors is given as a fixed value M, a first scaling factor Shift₁ corresponding to a short window may be determined to be a value customized according to a context model, and a second scaling factor Shift₂ corresponding to a long window may be determined to be Shift₁+M. According to another example, when a sum of two scaling factors is given as a fixed value M, a first scaling factor Shift₁ may be determined to be a value customized according to a context model, and a second scaling factor Shift₂ may be determined to be M−Shift₁.

According to another embodiment, a plurality of scaling factors may be determined such that a deviation or average of the plurality of scaling factors becomes a certain value being irrelevant to a context model. For example, a deviation of two scaling factors may be given as a fixed value M, and an average A of the two scaling factors may be customized according to a context model. In this case, a first scaling factor Shift₁ may be determined to be A−M, and a second scaling factor Shift₂ may be determined to be A+M. According to another example, an average of two scaling factors may be given as a fixed value M, and a deviation D of the two scaling factors may be customized according to a context model. In this case, a first scaling factor Shift₁ may be determined to be M−D, and a second scaling factor Shift₂ may be determined to be M+D.

According to the above-described embodiments, because a single value, instead of two scaling factors, is customized for each context model, a memory required for customizing scaling factors may be reduced to half or less. For example, a single scaling factor index shiftIdx, which is represented by n bits, may be customized for each context model.

In operation 2120, the context modeler 1720 may perform arithmetic coding on a binary value of the current encoding symbol, based on the occurrence probability of the certain binary value. The occurrence probability of the certain binary value may be a probability initialized based on a context model or a probability updated based on previous encoding symbols previously encoded.

In operation 2130, the context modeler 1720 may update the occurrence probability of the certain binary value by using at least one of the plurality of scaling factors, according to the binary value of the current encoding symbol. As described above, the context modeler 1720 may generate, upon a probability update, a plurality of updated probabilities by using a plurality of scaling factors, and determine a finally updated probability by using the plurality of updated probabilities. For example, the context modeler 1720 may update P₁ and P₂ by using two scaling factors Shifts and Shift₂ based on Equation 3, and determine an average of P₁ and P₂ to be a finally updated probability.

When a probability Pᵢ is represented as an integer between 0 and 2ₖ, like Equation 2, a memory of k bits may be required to represent a probability. Accordingly, when two scaling factors are used for each context model, two probabilities may need to be updated, and accordingly, a memory of k*2*[the number of context models] bits may be required. For example, when Pᵢ is represented by an integer that is equal to or smaller than 2¹⁵ and 400 context models are provided, RAM of 12000 bits (15*2*400=12000) may need to be secured to update probabilities.

Accordingly, to reduce a memory required for representing a probability, the context modeler 1720 according to various embodiments may determine whether to update a probability by using all of a plurality of scaling factors, or whether to update a probability by using some of the plurality of scaling factors, instead of using all of the plurality of scaling factors, based on a context model. According to an embodiment, when the context modeler 1720 determines to update a probability by using some of the plurality of scaling factors, the context modeler 1720 may update a probability by using one of the plurality of scaling factors. In this case, because a probability, for example, a value of P₁, needs to be updated, a memory required for representing the probability may be reduced.

According to an embodiment, some context models may be set to update a probability by using a plurality of scaling factors. For example, only context models for coefficient coding may be set to update a probability by using a plurality of scaling factors, and the other context models may be set to update a probability by using a scaling factor. Also, on the contrary, only other context models except for context models for coefficient coding may be set to update a probability by using a plurality of scaling factors, and context models for coefficient coding may be set to update a probability by using a scaling factor.

In various embodiments, the context modeler 1720 may count an update number of a probability after the probability is initialized, cause the probability to converge quickly into a proper value by using a scaling factor until the update number of the probability reaches a certain threshold, and update, after the update number of the probability exceeds the certain threshold, the probability by using a plurality of scaling factors to thereby cause the probability to quickly and stably converge into the proper value.

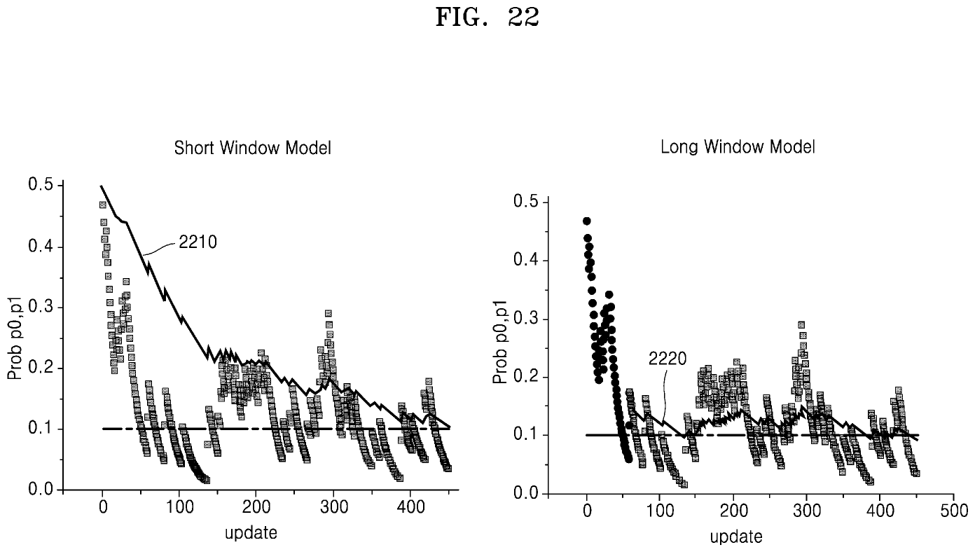

Hereinafter, a method of updating a probability by using a plurality of scaling factors based on an update number of the probability will be described in detail with reference to FIGS. 22 to 24.

FIG. 22 is a view for comparing a probability update process using one scaling factor with a probability update process using a plurality of scaling factors according to an update number of a probability, according to an embodiment of the disclosure.

Referring to FIG. 22, a graph 2210 represents a probability updated by using only a scaling factor corresponding to a short window. A graph 2220 represents a probability updated by using only a scaling factor until an update number reaches a certain threshold, as in the graph 2210, and then updated by using two scaling factors corresponding to a short window and a long window from after an update number exceeds the certain threshold. In this case, a probability value updated immediately before the update number reaches the certain threshold by using the one scaling factor may be used as an initial probability value to be updated by using the two scaling factors after the update number exceeds the certain threshold.

In the case of using the scaling factor corresponding to the short window, the probability may change quickly as the update number of the probability increases to quickly converge into a proper value, as described above. Meanwhile, in the case of using the scaling factor corresponding to the long window, fluctuations may less occur upon convergence of an updated probability into a proper value, so that a stable operation is possible without causing a sensitive response to errors, noise, etc. Accordingly, as shown in the graph 2220, the context modeler 1720 may update a probability by using a scaling factor, with respect to initial bins after probability initialization, to cause the probability to quickly converge into a proper value, and after data of bins is accumulated, the context modeler 1720 may update a probability by using a plurality of scaling factors, thereby stably predicting a probability.

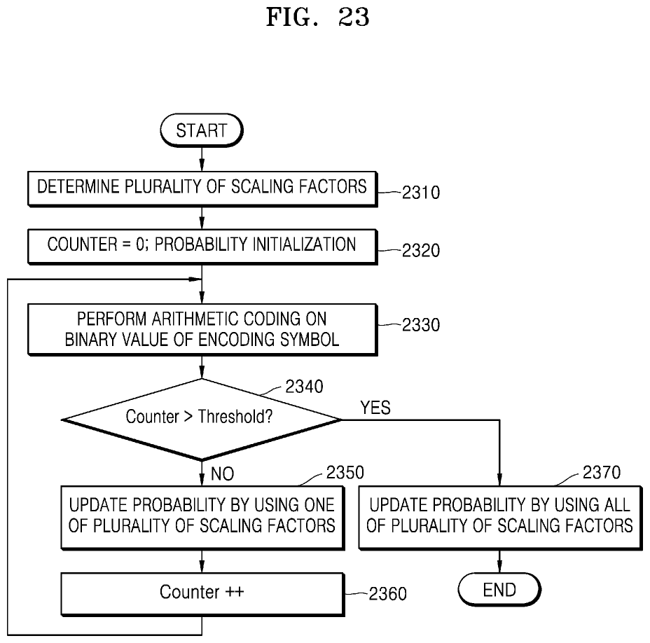

FIG. 23 is a flowchart of a probability update method using a plurality of scaling factors based on an update number of a probability, according to an embodiment of the disclosure. Operations 2310 and 2330 of FIG. 23 may respectively correspond to operations 2110 and 2120 of FIG. 21. Operations 2340 to 2370 of FIG. 23 may correspond to operation 2130 of FIG. 21.

Referring to FIG. 23, in operation 2310, the context modeler 1720 may determine a plurality of scaling factors for updating an occurrence probability of a certain binary value for a current encoding symbol.

In operation 2320, the context modeler 1720 may initialize a counter representing an update number of a probability to 0 after an entropy reset, and initialize an occurrence probability of a certain binary value.

In operation 2330, the context modeler 1720 may perform arithmetic coding on a binary value of the current encoding symbol, based on the occurrence probability of the certain binary value. The occurrence probability of the certain binary value may be a probability initialized based on a context model, or a probability updated based on previous encoding symbols previously encoded.

In operation 2340, the context modeler 1720 may determine whether an update number of a probability exceeds a certain threshold. According to an embodiment, the certain threshold may be a fixed value, for example, 31. According to another embodiment, the certain threshold may be a value customized according to a context model. According to another embodiment, the context modeler 1720 may use, with respect to some context models, thresholds respectively customized for the context models, and use, with respect to the other context models, a pre-customized, fixed value.

When the update number of the probability is less than or equal to the certain threshold, the context modeler 1720 may perform operation 2350. On the contrary, when the update number of the probability exceeds the certain threshold, the context modeler 1720 may perform operation 2370.

When the update number of the probability after probability initialization is less than or equal to the certain threshold, the context modeler 1720 may update the occurrence probability of the certain binary value by using one of the plurality of scaling factors, according to the binary value of the current encoding symbol, in operation 2350. For example, the context modeler 1720 may update P₁ by using a scaling factor Shift₁ corresponding to a short window based on Equation 2, and determine P₁ to be the occurrence probability of the certain binary value.

In operation 2360, the context modeler 1720 may increase a counter representing the update number of the probability by 1. The context modeler 1720 may repeat operations 2330 to 2360 to perform arithmetic encoding and probability updating on a next encoding symbol, until the counter exceeds the certain threshold.

When the update number of the probability after probability initialization exceeds the certain threshold, the context modeler 1720 may update the occurrence probability of the certain binary value by using all of the plurality of scaling factors, according to the binary value of the current encoding symbol, in operation 2370. As described above, the context modeler 1720 may generate a plurality of updated probabilities by using the plurality of scaling factors upon a probability update, and determine a finally updated probability by using the plurality of updated probabilities. For example, the context modeler 1720 may update P₁ and P₂ respectively by using two scaling factors Shift₁ and Shift₂, based on Equation 3, and determine an average of P₁ and P₂ to be a finally updated probability. When P₂ is first updated, P₁(t−1) updated immediately before an update number of the probability exceeds the certain threshold may be considered as a probability P₂(t−1) of a previous bin and calculated. In the following CABAC process, the context modeler 1720 may perform arithmetic coding and probability updating by continuing to use all of the plurality of scaling factors, until probability initialization.

According to another embodiment, the context modeler 1720 may update the occurrence probability of the certain binary value by using scaling factors that are different from those used in operation 2350 among the plurality of scaling factors, instead of using all of the plurality of scaling factors, in operation 2370. For example, the context modeler 1720 may update P₁ by using the first scaling factor Shift₁ corresponding to the small window and determine P₁ to be an occurrence probability of the certain binary value until an update number of the probability exceeds the certain threshold, and after an update number of the probability exceeds the certain threshold, the context modeler 1720 may update P₂ by using the second scaling factor Shift₂ corresponding to the long window and determine P₂ to be an occurrence probability of the certain binary value. When P₂ is first updated, P₂ may be calculated by considering P₁(t−1) updated immediately before an update number of a probability exceeds the certain threshold as a probability P₂(t−1) of a previous bin. In this case, because only one probability variable is used, a required memory may be further reduced.

In the probability update methods based on the probability update number according to the above-described embodiments, an additional memory space for storing a current update number of a probability may be required. When the certain threshold is represented by n bits, a memory of n*[the number of context models] bits may be required to store an update number of a probability for each context model. For example, when the certain threshold is 31, a minimum of 5 bits may be required to represent a counter. Therefore, when 400 context models are provided, RAM of 2000 bits (5*400=2000) may be required.

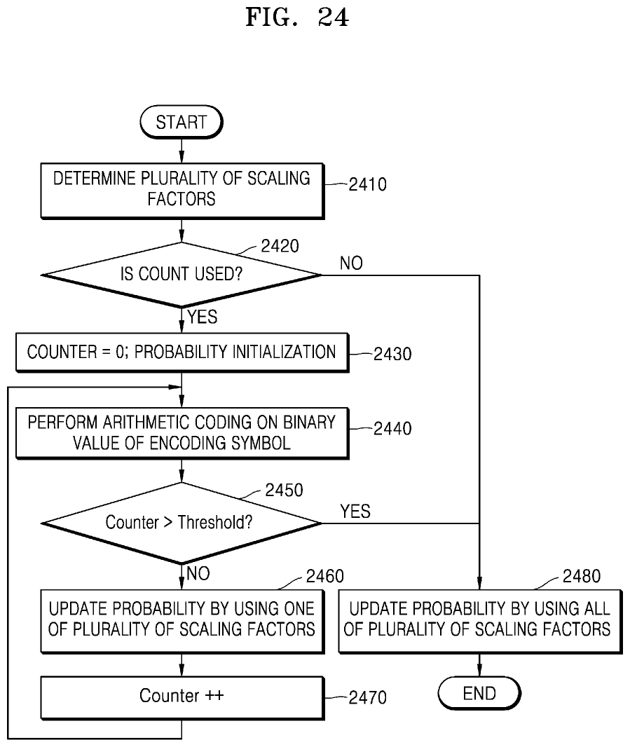

Accordingly, the context modeler 1720 according to various embodiments may determine whether to use a counter to update a probability, thereby saving a memory required for the counter. Hereinafter, a detailed description will be given with reference to FIG. 24.

FIG. 24 is a flowchart of a probability update method using a plurality of scaling factors based on an update number of a probability, according to an embodiment of the disclosure. Operations 2410 and 2440 of FIG. 24 may respectively correspond to operations 2110 and 2120 of FIG. 21. Operations 2450 and 2480 of FIG. 24 may correspond to operation 2130 of FIG. 21.

Referring to FIG. 24, in operation 2410, the context modeler 1720 may determine a plurality of scaling factors for updating an occurrence probability of a certain binary value for a current encoding symbol. Operation 2410 may correspond to operation 2110 of FIG. 21, and therefore, overlapping descriptions will be omitted.

In operation 2420, the context modeler 1720 may determine whether to count an update number of a probability based on a context model. When the context modeler 1720 determines to count an update number of a probability, the context modeler 1720 may perform operation 2430. Meanwhile, when the context modeler 1720 determines not to count an update number of a probability, the context modeler 1720 may perform operation 2480.

According to an embodiment, the context modeler 1720 may be set to update a probability by counting an update number of the probability, with respect to a context model for coefficient coding. Coefficient coding may be relatively frequently generated, whereas an occurrence frequency of encoding symbols not being coefficients may be less than or equal to a certain threshold. Accordingly, it may be more effective to count an update number of a probability only with respect to a context model for coefficient coding. That is, the context modeler 1720 may be set to count, with respect to a context model for coefficient coding, an update number of a probability and update the probability by using a plurality of scaling factors from after the update number of the probability exceeds the certain threshold, and to update, with respect to another context model, a probability by using the plurality of scaling factors from the beginning.

According to another embodiment, the context modeler 1720 may be set to update, only with respect to another context model except for context models for coefficient coding, a probability by counting an update number of the probability. Because an encoding symbol not being a coefficient may have higher sensitiveness upon a probability update, it may be more effective to count an update number of a probability with respect to the other context models except for context models for coefficient coding. That is, the context modeler 1720 may be set to count, with respect to another context model except for context models for coefficient coding, an update number of a probability and update the probability by using the plurality of scaling factors from after the update number of the probability exceeds the certain threshold. Also, the context modeler 1720 may be set to update, with respect to a context model for coefficient coding, a probability by using the plurality of scaling factors from the beginning.

When the context modeler 1720 determines to count an update number of a probability, the context modeler 1720 may initialize a counter representing the update number of the probability to 0, and initialize the occurrence probability of the certain binary value, in operation 2430.

In operation 2440, the context modeler 1720 may perform arithmetic coding on a binary value of the current encoding symbol, based on the occurrence probability of the certain binary value. The occurrence probability of the certain binary value may be a probability initialized based on a context model, or a probability updated based on previous encoding symbols previously encoded.

In operation 2450, the context modeler 1720 may determine whether the update number of the current probability exceeds the certain threshold. When the context modeler 1720 determines that the update number of the current probability is less than the certain threshold, the context modeler 1720 may perform operation 2460. When the context modeler 1720 determines that the update number of the current probability exceeds the certain threshold, the context modeler 1720 may perform operation 2480.

When the update number of the probability after initialization of the probability is less than the certain threshold, the context modeler 1720 may update the occurrence probability of the certain binary value by using one of the plurality of scaling factors, according to the binary value of the current encoding symbol, in operation 2460. For example, the context modeler 1720 may update P₁ by using a scaling factor Shift₁ corresponding to a small window, based on Equation 2, and determine P₁ to be an occurrence probability of the certain binary value.

In operation 2470, the context modeler 1720 may increase a counter representing an update number of the probability by 1. The context modeler 1720 may repeat operations 2440 to 2470 to perform arithmetic coding and probability updating on a next encoding symbol, until the counter exceeds the certain threshold.

When the context modeler 1720 determines not to count the update number of the probability, or when an update number of a probability after probability initialization exceeds the certain threshold, the context modeler 1720 may update the occurrence probability of the certain binary value by using all of the plurality of scaling factors, according to the binary value of the current encoding symbol, in operation 2480. As described above, the context modeler 1720 may generate, upon a probability update, a plurality of updated probabilities by using the plurality of scaling factors, and determine a finally updated probability by using the plurality of updated probabilities. For example, the context modeler 1720 may update P₁ and P₂ by using two scaling factors Shift₁ and Shift₂ based on Equation 3, and determine an average of P₁ and P₂ to be a finally updated probability. When the update number of the probability is counted, a finally updated P₁(t−1) with respect to a first updated P₂ may be used as a probability P₂(t−1) of a previous bin. In the following CABAC process, the context modeler 1720 may update a probability by continuing to use all of the plurality of scaling factors until initialization of the probability.

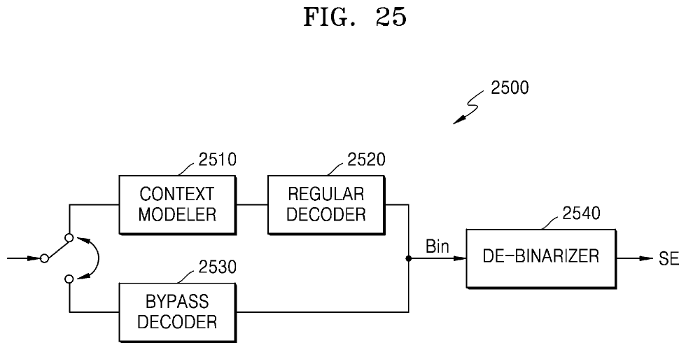

FIG. 25 is a block diagram illustrating a configuration of an entropy decoding apparatus according to an embodiment of the disclosure.

Referring to FIG. 25, an entropy decoding apparatus 2500 may include a context modeler 2510, a regular decoder 2520, a bypass decoder 2530, and a de-binarizer 2540. The entropy decoding apparatus 2500 may perform an inverse process of an entropy encoding process performed by the entropy encoding apparatus 1700 described above.

Bins encoded by bypass coding may be output to the bypass decoder 2530 and decoded, and bins encoded by regular coding may be decoded by the regular decoder 2520. The regular decoder 2520 may perform arithmetic decoding on a current bin provided from the context modeler 2510 by using a probability of a binary value determined based on previous bins decoded before the current bin is decoded.

The context modeler 2510 may provide a probability model for bins to the regular decoder 2520. More particularly, the context modeler 2510 may determine a probability of a certain binary value based on the previously decoded bins, update a probability of a binary value used to decode the previous bins, and output the updated probability to the regular decoder 2320.

The context modeler 2510 according to an embodiment of the disclosure may determine a plurality of scaling factors for updating an occurrence probability of a certain binary value for a current encoding symbol. The context modeler 2510 may update the occurrence probability of the certain binary value by using at least one of the plurality of scaling factors, according to the binary value of the current encoding symbol. The probability update process performed by the context modeler 2510 may be the same as the probability update process performed in the above-described encoding process, and therefore, a detailed description thereof will be omitted.

The de-binarizer 2540 may again map bin strings reconstructed by the regular decoder 2520 or the bypass decoder 2530 to syntax elements, and reconstruct the bin strings.

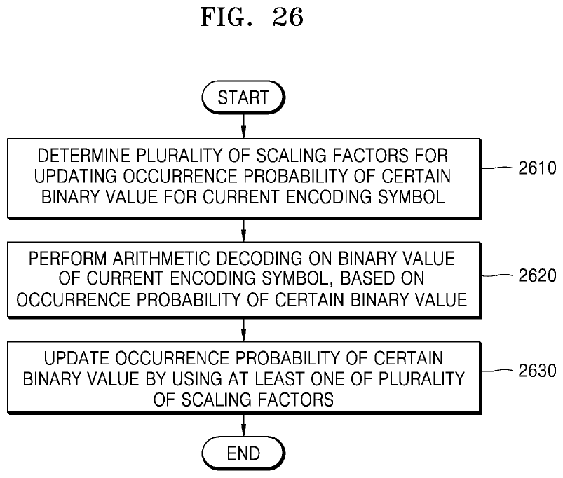

FIG. 26 is a flowchart of a probability update method using a plurality of scaling factors, according to an embodiment of the disclosure.

Referring to FIG. 26, in operation 2610, the context modeler 2510 may determine a plurality of scaling factors for updating an occurrence probability of a certain binary value for a current encoding symbol. As described above, in various embodiments, the context modeler 2510 may determine the plurality of scaling factors to be, for example, values customized fora context model, based on the context model. In various embodiments, the context modeler 2510 may determine all or some of the plurality of scaling factors based on a value being irrelevant to a context model.

In operation 2620, the context modeler 2510 may perform arithmetic decoding on a binary value of a current encoding symbol, based on the occurrence probability of the certain binary value. The occurrence probability of the certain binary value may be a probability initialized based on the context model, or a probability updated based on previous encoding symbols decoded in advance.

In operation 2630, the context modeler 2510 may update the occurrence probability of the certain binary value by using at least one of the plurality of scaling factors, according to the binary value of the current encoding symbol.

As described above, the context modeler 2510 may generate, upon a probability update, a plurality of updated probabilities by using the plurality of scaling factors, and determine a finally updated probability by using the plurality of updated probabilities. For example, the context modeler 2510 may update P₁ and P₂ by using two scaling factors Shifts and Shift₂ based on Equation 2, and determine an average of P₁ and P₂ to be a finally updated probability. In various embodiments, the context modeler 2510 may determine whether to update a probability by using all of a plurality of scaling factors, or whether to update a probability by using some of the plurality of scaling factors, instead of using all of the plurality of scaling factors, based on a context model.

As described above, the context modeler 2510 may determine whether an update number of a current probability after probability initialization exceeds a certain threshold. When the context modeler 2510 determines that the update number of the current probability is less than or equal to the certain threshold, the context modeler 2510 may update the occurrence probability of the certain binary value by using one of the plurality of scaling factors, and, when the context modeler 2510 determines that the update number of the current probability after probability initialization exceeds the certain threshold, the context modeler 2510 may update the occurrence probability of the certain binary value by using all of the plurality of scaling factors. In various embodiments, the context modeler 2510 may determine whether to count an update number of a probability, based on the context model.

So far, various embodiments have been described. It will be understood by one of ordinary skill in the art to which the disclosure belongs that modifications can be made within a range not deviating from the intrinsic properties of the disclosure. Therefore, the disclosed embodiments should be considered from a descriptive standpoint rather than a restrictive standpoint. The scope of the disclosure is defined in the accompanying claims rather than the above detailed description, and it should be noted that all differences falling within the claims and equivalents thereof are included in the scope of the disclosure.

Meanwhile, the embodiments of the disclosure may be written as a program that is executable on a computer, and implemented on a general-purpose digital computer that operates a program using a computer-readable recording medium. The computer-readable recording medium may include a storage medium, such as a magnetic storage medium (for example, read only memory (ROM), a floppy disk, a hard disk, etc.) and an optical reading medium (for example, compact disc ROM (CD-ROM), digital versatile disc (DVD), etc.).

1. An entropy decoding method comprising:
determining a plurality of scaling factors for updating an occurrence probability of a certain binary value for a current encoding symbol;
performing arithmetic coding on a binary value of the current encoding symbol, based on the occurrence probability of the certain binary value; and
updating the occurrence probability of the certain binary value by using at least one scaling factor of the plurality of scaling factors, according to the binary value of the current encoding symbol.

2. The entropy decoding method of claim 1, wherein the updating of the occurrence probability of the certain binary value comprises:
determining whether to use all of the plurality of scaling factors, based on a context model; and
updating, when it is determined not to use all of the plurality of scaling factors, the occurrence probability of the certain binary value by using a scaling factor of the plurality of scaling factors.

3. The entropy decoding method of claim 2, wherein whether to use all of the plurality of scaling factors is determined based on whether the context model is a context model for coefficient coding.

4. The entropy decoding method of claim 1, wherein the updating of the occurrence probability of the certain binary value comprises:
counting an update number of a probability after probability initialization;
updating, when the update number of the probability is less than or equal to a threshold, the occurrence probability of the certain binary value by using a scaling factor of the plurality of scaling factors; and
updating, when the update number of the probability is greater than the threshold, the occurrence probability of the certain binary value by using all of the plurality of scaling factors.

5. The entropy decoding method of claim 1, wherein the updating of the occurrence probability of the certain binary value comprises:
counting an update number of a probability after probability initialization;
updating, when the update number of the probability is less than or equal to a threshold, the occurrence probability of the certain binary value by using a first scaling factor of the plurality of scaling factors; and
updating, when the update number of the probability is greater than the threshold, the occurrence probability of the certain binary value by using a second scaling factor of the plurality of scaling factors.

6. The entropy decoding method of claim 4 or 5, wherein the updating of the occurrence probability of the certain binary value further comprises:
determining whether to count the update number of the probability, based on a context model; and
updating, when it is determined not to count the update number of the probability, the occurrence probability of the certain binary value by using all of the plurality of scaling factors.

7. The entropy decoding method of claim 6, wherein whether to count the update number of the probability is determined based on whether the context model is a context model for coefficient coding.

8. The entropy decoding method of claim 1, wherein the plurality of scaling factors are determined to be values customized according to a context model.

9. The entropy decoding method of claim 8, wherein, when there are no values customized according to the context model, the plurality of scaling factors are determined to be a certain reference value.

10. The entropy decoding method of claim 1, wherein the determining of the plurality of scaling factors comprises determining at least one scaling factor of the plurality of the scaling factors to be a certain value being irrelevant to a context model.

11. The entropy decoding method of claim 1, wherein the determining of the plurality of scaling factors comprises determining the plurality of scaling factors such that a sum of or difference between the plurality of scaling factors becomes a certain value being irrelevant to a context model.

12. The entropy decoding method of claim 1, wherein the determining of the plurality of scaling factors comprises determining the plurality of scaling factors such that a deviation or average of the plurality of scaling factors becomes a certain value being irrelevant to a context model.

13. An entropy decoding apparatus comprising:
at least one processor; and
a memory,
wherein the memory stores at least one instruction configured to be executable by the at least one processor, and
the at least one instruction is set to cause, when being executed, the at least one processor to
determine a plurality of scaling factors for updating an occurrence probability of a certain binary value for a current encoding symbol, based on a context model,
perform arithmetic coding on a binary value of the current encoding symbol, based on the occurrence probability of the certain binary value, and
update the occurrence probability of the certain binary value by using at least one scaling factor of the plurality of scaling factors, according to the binary value of the current encoding symbol.

14. An entropy encoding method comprising:
determining a plurality of scaling factors for updating an occurrence probability of a certain binary value for a current encoding symbol, based on a context model;
performing arithmetic coding on a binary value of the current encoding symbol, based on the occurrence probability of the certain binary value; and
updating the occurrence probability of the certain binary value by using at least one scaling factor of the plurality of scaling factors, according to the binary value of the current encoding symbol.

15. An entropy encoding apparatus comprising:
at least one processor; and
a memory,
wherein the memory stores at least one instruction configured to be executable by the at least one processor, and
the at least one instruction is set to cause, when being executed, the at least one processor to
determine a plurality of scaling factors for updating an occurrence probability of a certain binary value for a current encoding symbol, based on a context model,
perform arithmetic coding on a binary value of the current encoding symbol, based on the occurrence probability of the certain binary value; and
update the occurrence probability of the certain binary value by using at least one scaling factor of the plurality of scaling factors, according to the binary value of the current encoding symbol.
